(19) United States
(12) Patent Application Publication
(10) Pub. No.: US 2007/0081065 A1
(43) Pub. Date: Apr. 12, 2007

(54) Image forming apparatus

(75) Inventors: Masao Ootsuka, Osaka (JP); Takanori Nakano, Osaka (JP); Noriyuki Tajima, Osaka (JP); Hiroshi Terada, Nara (JP); Terutaka Okamoto, Nara (JP); Hironobu Kinoshita, Fukuoka (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 11/433,491

(22) Filed: May 15, 2006

(30) Foreign Application Priority Data
May 16, 2005 (JP) 2005-142725

(51) Int. Cl. B41J 2/01

(52) U.S. Cl. 347/104

(57) ABSTRACT

An image forming apparatus with three-dimensional object imaging capability is provided that is compact, has a small footprint, and is easy to use. This apparatus has a top-surface paper ejection unit (130) that ejects paper P on which an image has been formed by an image forming unit (110) onto the top surface of the apparatus body (101); a top-surface paper ejection tray (150) that can be opened and closed with respect to the apparatus body (101) and receives paper P ejected by the top-surface paper ejection unit (130); an object placement platform (160) whose object placement surface (161), on which an object is placed, is exposed by opening the top-surface paper ejection tray (150); and a two-dimensional sensor (170) for imaging an object placed on the object placement platform (160). The apparatus has a configuration in which the top-surface paper ejection tray (150), when open, serves as a support for the imaging section. In this image forming apparatus (100), the top-surface paper ejection tray (150) also functions as a support for the two-dimensional sensor (170).

### BACKGROUND OF THE INVENTION

1. Field of the Invention

The present invention relates to an image forming apparatus such as a monochrome or color copier, printer, or facsimile that employs an image forming method such as electrophotography, electrostatic recording, ionography, or magnetic recording, and more particularly to an image forming apparatus capable of imaging a three-dimensional object.

2. Description of Related Art

Hitherto, a color image processing apparatus that uses a digital camera as the imaging section of the scanner section in an MFP (Multi-Function Peripheral) comprising a multifunction all-in-one printer (hereinafter referred to simply as “image forming apparatus”) has been proposed as an image forming apparatus capable of imaging a three-dimensional object (see, for example, Japanese Patent Application Laid-Open No. 2003-348286).

FIG. 1 is a schematic oblique drawing of an image forming apparatus described in the above-mentioned publication.

In image forming apparatus 10 described in the above-mentioned publication, a USB interface section, ink-jet printer (hereinafter referred to simply as “printer section”), scanner section (not shown), and so forth are housed in the main body of the apparatus (hereinafter referred to as “apparatus body”) 11.

Also, as shown in FIG. 1, frame 13 for securing digital camera 12 is attached to apparatus body 11 so as to extend above the center of apparatus body 11. Digital camera 12 is fixed to frame 13, and is connected to apparatus body 11 by USB cable 14.

Object placement platform 15 for placing an object to be photographed by digital camera 12, and operating section 16 operated by an operator, are provided on the top of apparatus body 11.

At the sides of apparatus body 11 are provided paper feed section 17 for paper on which printing (image formation) is performed by a printer section, and a paper ejection section 18 for paper printed by the printer section.

This image forming apparatus 10 has three operating modes: copy mode, scanner mode, and printer mode.

In copy mode, image data is input and copied directly from the scanner section of apparatus body 11 to the printer section. In scanner mode, image data of a document read by the scanner section of apparatus body 11 is transferred as RGB image data to a computer or the like connected to image forming apparatus 10. In printer mode, RGB image data stored in an external computer or the like is read and printed onto paper by the printer section of apparatus body 11.

Referring to FIG. 1, when copy mode is executed, a book or suchlike object (not shown) is placed on object placement platform 15 of apparatus body 11, and the object is photographed (scanned) by digital camera 12. Then the image data captured by digital camera 12 is transferred to the printer section of apparatus body 11. By this means, image data captured by digital camera 12 is printed on paper by the printer section, and paper on which the image data has been printed is ejected into paper ejection section 18 of apparatus body 11.

However, image forming apparatus 10 described in the above-mentioned publication has the following problems.

In this image forming apparatus 10, digital camera 12 serving as an imaging section is fixed to frame 13 extending above apparatus body 11. Therefore, a problem with this image forming apparatus 10 is that the apparatus is large.

Also, in this image forming apparatus 10, the top of apparatus body 11 forms object placement platform 15 for placing an object to be photographed by digital camera 12. Therefore, a problem with this image forming apparatus 10 is that it is necessary for paper feed section 17 and paper ejection section 18 to be provided at the sides of apparatus body 11, resulting in a large apparatus footprint.

Furthermore, in this image forming apparatus 10, paper ejection section 18 is located at the front of apparatus body 11, and paper feed section 17 is concealed at the rear of apparatus body 11. Therefore, a problem with this image forming apparatus 10 is that operations to set paper in paper feed section 17 are difficult.

There are thus various problems with using this image forming apparatus 10 placed on a desk in the manner of a typical MFP.

### SUMMARY OF THE INVENTION

It is therefore an object of the present invention to provide an image forming apparatus with three-dimensional object imaging capability that is compact, has a small footprint, and is easy to use.

According to an aspect of the invention, an image forming apparatus employs a configuration that includes: an image forming section that forms an image; a top-surface paper ejection section that ejects paper on which an image has been printed by the image forming section onto the top surface of the apparatus body; a top-surface paper ejection tray that can be opened and closed with respect to the apparatus body and receives paper ejected by the top-surface paper ejection section; an object placement platform on which an object placement surface on which an object is placed is exposed by opening the top-surface paper ejection tray; and an imaging section that has the top-surface paper ejection tray in an open state with respect to the apparatus body as a supporting member and images an object placed on the object placement platform.

According to the present invention, paper is ejected onto the top surface of the apparatus body, and a top-surface paper ejection tray serves as a supporting member of the imaging section, enabling an apparatus capable of imaging a three-dimensional object to be made compact and the footprint of the apparatus to be made small.

### BRIEF DESCRIPTION OF THE DRAWINGS

The above and other objects and features of the invention will appear more fully hereinafter from a consideration of the following description taken in conjunction with the accompanying drawings, in which:

FIG. 1 is a schematic oblique drawing showing an example of a conventional image forming apparatus;

FIG. 2 is a schematic oblique drawing showing the outward appearance of an image forming apparatus according to Embodiment 1 of the present invention;

FIG. 3 is a schematic configuration diagram showing the overall configuration of an image forming apparatus according to Embodiment 1 of the present invention;

FIG. 4 is a schematic oblique drawing for explaining the configuration of an image forming apparatus according to Embodiment 1 of the present invention;

FIG. 5 is a schematic configuration diagram for explaining the configuration of an image forming apparatus according to Embodiment 1 of the present invention;

FIG. 6 is a schematic diagram for explaining the positional relationship between a two-dimensional sensor and a top-surface paper ejection tray and between a two-dimensional sensor and an object placement platform in an image forming apparatus according to Embodiment 1 of the present invention;

FIG. 7 is a schematic diagram for explaining the imaging position of a two-dimensional sensor with respect to an object in an image forming apparatus according to Embodiment 1 of the present invention;

FIG. 8 is a schematic diagram for explaining the placement reference position of an object with respect to the object placement surface of the object placement platform in an image forming apparatus according to Embodiment 1 of the present invention;

FIG. 9 is a schematic configuration diagram showing the configuration of an image forming apparatus according to Embodiment 2 of the present invention with the top-surface paper ejection tray in a closed state;

FIG. 10 is a schematic configuration diagram showing the configuration of an image forming apparatus according to Embodiment 2 of the present invention with the top-surface paper ejection tray in an open state;

FIG. 11 is a schematic oblique drawing showing the outward appearance of an image forming apparatus according to Embodiment 2 of the present invention with the top-surface paper ejection tray in an open state;

FIG. 12 is a schematic oblique drawing showing the outward appearance of an image forming apparatus according to Embodiment 3 of the present invention with the top-surface paper ejection tray in a closed state;

FIG. 13 is a schematic oblique drawing showing the outward appearance of an image forming apparatus according to Embodiment 3 of the present invention with the top-surface paper ejection tray in an open state;

FIG. 14 is a schematic oblique drawing showing the outward appearance of another configuration of an image forming apparatus according to Embodiment 3 of the present invention with a top-surface paper ejection tray in a closed state;

FIG. 15 is a schematic oblique drawing showing the outward appearance of another configuration of an image forming apparatus according to Embodiment 3 of the present invention with a top-surface paper ejection tray in an open state;

FIG. 16 is a schematic configuration diagram showing the configuration of essential parts of an image forming apparatus according to Embodiment 4 of the present invention;

FIG. 17 is a schematic configuration diagram showing another configuration of an image forming apparatus according to Embodiment 4 of the present invention;

FIG. 18 is a schematic configuration diagram showing yet another configuration of an image forming apparatus according to Embodiment 4 of the present invention;

FIG. 19 is a schematic configuration diagram showing the configuration of essential parts of an image forming apparatus according to Embodiment 5 of the present invention;

FIG. 20 is a block diagram for explaining the image signal flow in an image forming apparatus according to Embodiment 5 of the present invention;

FIG. 21 is a schematic configuration diagram showing the configuration of the supporting member of the top-surface paper ejection tray in an image forming apparatus according to Embodiment 6 of the present invention;

FIG. 22 is a schematic drawing showing an image forming apparatus according to Embodiment 6 of the present invention with the top-surface paper ejection tray in a closed state;

FIG. 23 is a schematic drawing showing an image forming apparatus according to Embodiment 6 of the present invention with the top-surface paper ejection tray opened to the imaging position;

FIG. 24 is a schematic drawing showing an image forming apparatus according to Embodiment 6 of the present invention with the top-surface paper ejection tray opened to the maximum extent;

FIG. 25 is a schematic drawing showing an image forming apparatus according to Embodiment 7 of the present invention with the top-surface paper ejection tray in an open state;

FIG. 26 is a schematic drawing showing an image forming apparatus according to Embodiment 7 of the present invention with the top-surface paper ejection tray in a closed state;

FIG. 27 is a schematic oblique drawing showing the outward appearance of an image forming apparatus according to Embodiment 8 of the present invention with the top-surface paper ejection tray in an open state;

FIG. 28 is a schematic oblique drawing showing the outward appearance of an image forming apparatus according to Embodiment 9 of the present invention with the top-surface paper ejection tray in an open state;

FIG. 29 is a schematic oblique drawing showing the configuration of an XY table that moves a two-dimensional sensor of an image forming apparatus according to each embodiment of the present invention in two-dimensional directions;

FIG. 30 is a schematic oblique drawing showing the outward appearance of an image forming apparatus according to Embodiment 10 of the present invention with the top-surface paper ejection tray in a closed state;

FIG. 31 is a schematic configuration diagram showing the configuration of an image forming apparatus according to Embodiment 10 of the present invention with the top-surface paper ejection tray in a closed state;

FIG. 32 is a schematic oblique drawing showing the outward appearance of an image forming apparatus according to Embodiment 10 of the present invention with the top-surface paper ejection tray in an open state;

FIG. 33 is a schematic configuration diagram showing the configuration of an image forming apparatus according to Embodiment 10 of the present invention with the top-surface paper ejection tray in an open state;

FIG. 34 is a schematic configuration diagram showing another configuration of an image forming apparatus according to Embodiment 10 of the present invention with the top-surface paper ejection tray in an open state;

FIG. 35 is a schematic configuration diagram showing another configuration of an image forming apparatus according to Embodiment 10 of the present invention with the top-surface paper ejection tray in a closed state;

FIG. 36 is a schematic configuration diagram showing yet another configuration of an image forming apparatus according to Embodiment 10 of the present invention with the top-surface paper ejection tray in a closed state;

FIG. 37 is a schematic configuration diagram showing the configuration of an imaging section of an image forming apparatus according to Embodiment 11 of the present invention with the top-surface paper ejection tray in a closed state;

FIG. 38 is a schematic configuration diagram showing the configuration of an imaging section of an image forming apparatus according to Embodiment 11 of the present invention with the top-surface paper ejection tray in an open state;

FIG. 39 is a schematic configuration diagram showing the configuration of an image forming apparatus according to Embodiment 12 of the present invention with the top-surface paper ejection tray in a closed state;

FIG. 40 is a schematic configuration diagram showing the configuration of an image forming apparatus according to Embodiment 12 of the present invention with the top-surface paper ejection tray opened to the imaging position;

FIG. 41 is a schematic configuration diagram showing the configuration of an image forming apparatus according to Embodiment 12 of the present invention with the top-surface paper ejection tray opened to the maximum extent;

FIG. 42 is a schematic configuration diagram showing the configuration of an image forming apparatus according to Embodiment 13 of the present invention with the top-surface paper ejection tray opened to the imaging position;

FIG. 43 is a schematic configuration diagram showing the configuration of an image forming apparatus according to Embodiment 14 of the present invention with the top-surface paper ejection tray opened to the imaging position;

FIG. 44 is a schematic oblique drawing showing the configuration of an image forming apparatus according to Embodiment 14 of the present invention with the top-surface paper ejection tray opened to the imaging position;

FIG. 45 is a schematic configuration diagram showing the configuration of an image forming apparatus according to Embodiment 15 of the present invention with the top-surface paper ejection tray in a closed state;

FIG. 46 is a schematic configuration diagram showing another configuration of an image forming apparatus according to Embodiment 15 of the present invention with the top-surface paper ejection tray in a closed state;

FIG. 47 is a schematic configuration diagram showing yet another configuration of an image forming apparatus according to Embodiment 15 of the present invention with the top-surface paper ejection tray in a closed state;

FIG. 48 is a schematic configuration diagram showing still another configuration of an image forming apparatus according to Embodiment 15 of the present invention with the top-surface paper ejection tray in a closed state;

FIG. 49 is a schematic configuration diagram showing the configuration of an image forming apparatus according to Embodiment 16 of the present invention with the top-surface paper ejection tray in an open state;

FIG. 50 is a schematic configuration diagram showing the configuration of an image forming apparatus according to Embodiment 17 of the present invention with the top-surface paper ejection tray in an open state;

FIG. 51 is an essential-part schematic configuration diagram showing the configuration of a supporting section of the two-dimensional sensor of an image forming apparatus according to each embodiment of the present invention;

FIG. 52 is an essential-part schematic configuration diagram showing the configuration of a supporting section of the two-dimensional sensor of an image forming apparatus according to each embodiment of the present invention with the top-surface paper ejection tray in an open state;

FIG. 53 is an essential-part schematic configuration diagram showing another configuration of a supporting section of the two-dimensional sensor of an image forming apparatus according to each embodiment of the present invention with the top-surface paper ejection tray in an open state;

FIG. 54 is an essential-part schematic configuration diagram showing the configuration of a tray latching section that latches the top-surface paper ejection tray of an image forming apparatus according to an embodiment of the present invention in a predetermined closed position and open position;

FIG. 55 is an essential-part schematic configuration diagram showing the top-surface paper ejection tray latched in a predetermined open position by the tray latching section;

FIG. 56 is an essential-part schematic configuration diagram showing the configuration of another tray latching section that latches the top-surface paper ejection tray of an image forming apparatus according to an embodiment of the present invention in a predetermined closed position and open position;

FIG. 57 is an essential-part schematic configuration diagram showing the top-surface paper ejection tray latched in a predetermined open position by the other tray latching section;

FIG. 58 is an essential-part schematic configuration diagram showing the configuration of yet another tray latching section that latches the top-surface paper ejection tray of an image forming apparatus according to an embodiment of the present invention in an arbitrary closed position and open position;

FIG. 59 is an essential-part schematic configuration diagram showing the top-surface paper ejection tray latched in an arbitrary open position by the yet other tray latching section;

FIG. 60 is an essential-part schematic configuration diagram showing the configuration of still another tray latching section that latches the top-surface paper ejection tray of an image forming apparatus according to an embodiment of the present invention in an arbitrary closed position and open position;

FIG. 61 is a schematic configuration diagram showing the configuration of a two-piece top-surface paper ejection tray of an image forming apparatus according to an embodiment of the present invention;

FIG. 62 is a schematic configuration diagram showing the configuration of the two-piece top-surface paper ejection tray in an open state;

FIG. 63 is a schematic configuration diagram showing the configuration of an image forming apparatus in which the top-surface paper ejection tray is provided with a paper fall prevention member;

FIG. 64 is a schematic oblique drawing showing the outward appearance of an image forming apparatus in which the top-surface paper ejection tray is provided with a paper fall prevention member;

FIG. 65 is a schematic configuration diagram showing the configuration of an image forming apparatus provided with monitors that display the captured image of an object; and

FIG. 66 is a schematic configuration diagram showing the configuration of an image forming apparatus provided with an open/closed detection section that detects the open/closed state of the top-surface paper ejection tray.

### DESCRIPTION OF THE PREFERRED EMBODIMENTS

With reference now to the accompanying drawings, embodiments of the present invention will be explained in detail below. Configuration elements and equivalent parts in the drawings having the same configuration or function are assigned the same codes, and descriptions thereof are not repeated.

### Embodiment 1

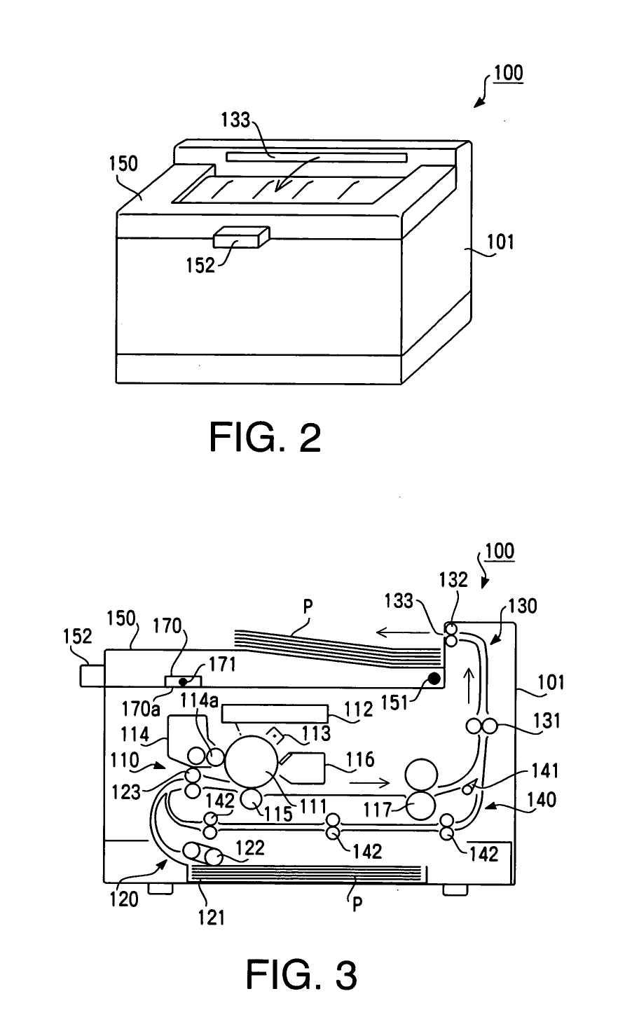

First, an image forming apparatus according to Embodiment 1 of the present invention will be described with reference to FIG. 2 and FIG. 3. FIG. 2 is a schematic oblique drawing showing the outward appearance of an image forming apparatus according to Embodiment 1 of the present invention, and FIG. 3 is a schematic configuration diagram showing the overall configuration of an image forming apparatus according to Embodiment 1 of the present invention.

As shown in FIG. 2 and FIG. 3, image forming apparatus 100 of this example is provided with an image forming unit 110 as an image forming section that forms an image on an OHP sheet, printing paper, or suchlike paper P.

Image forming unit 110 in image forming apparatus 100 of this example is composed of photosensitive drum 111, laser optical unit 112, an electrifier 113, developing unit 114, transfer roller 115, cleaning unit 116, fixing unit 117, and so forth.

Developing unit 114 in image forming apparatus 100 of this example comprises a magnetic brush contact type, bi-component development type developing apparatus provided with magnet roller 114a.

Image forming apparatus 100 of this example is also provided with paper feed unit 120 that feeds paper P toward image forming unit 110. In image forming apparatus 100 of this example, paper feed unit 120 is composed of paper feed cassette 121 that holds stacked paper P, paper feed roller 122 that separates and feeds paper P from paper feed cassette 121 one sheet at a time, registration rollers 123 that temporarily halt fed paper P and then re-feed it at predetermined timing, and so forth.

Image forming apparatus 100 of this example is also provided with top-surface paper ejection unit 130 as a top-surface paper ejection section that ejects paper P on which an image has been formed by image forming unit 110 onto the top surface of apparatus body 101. In image forming apparatus 100 of this example, top-surface paper ejection unit 130 is composed of transport rollers 131 that transport paper P on which an image has been formed by image forming unit 110 toward the upper part of apparatus body 101, top-surface paper ejection rollers 132 that eject paper P transported by transport rollers 131 toward the top surface of apparatus body 101, top-surface paper ejection aperture 133 provided at the top of apparatus body 101, and so forth.

When images are formed on both sides of paper P, image forming apparatus 100 of this example is also provided with reverse transportation unit 140 that reverses the front and back sides of paper P on one side (the surface) of which an image has been formed by image forming unit 110, and transports reversed paper P to image forming unit 110 again. In image forming apparatus 100 of this example, reverse transportation unit 140 is composed of paper path switching member (switching lug) 141 that switches the path of paper P on one side (the surface) of which an image has been formed to a reverse transportation path, reverse transportation rollers 142 that perform reverse transportation of paper P sent into the reverse transportation path toward registration rollers 123 of paper feed unit 120, and so forth.

Image forming apparatus 100 of this example is also provided with top-surface paper ejection tray 150 that can be opened and closed with respect to apparatus body 101 and receives paper P ejected by top-surface paper ejection unit 130. In image forming apparatus 100 of this example, top-surface paper ejection tray 150 is supported in a freely pivoting fashion by spindle 151, and is opened or closed with respect to apparatus body 101 by being raised or lowered by means of handle 152 provided on the opening and closing side.

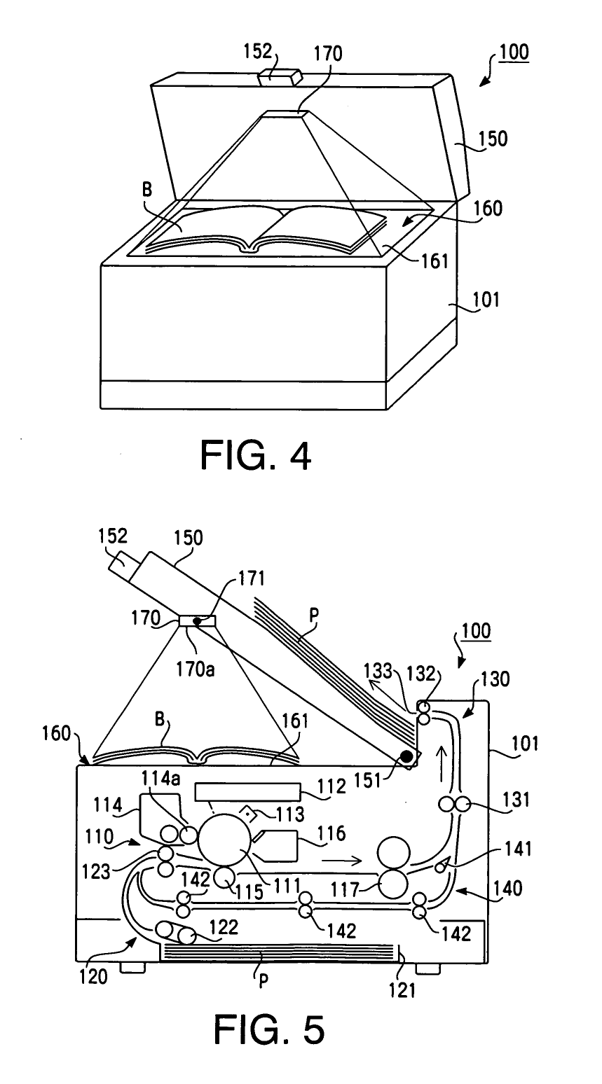

Image forming apparatus 100 of this example is also provided with object placement platform 160 on which a three-dimensional object can be placed (see FIG. 4 and FIG. 5). As shown in FIG. 4 and FIG. 5, in image forming apparatus 100 of this example, object placement platform 160 is configured so that an object placement surface 161 on which an object (here a book B) is placed is exposed by opening top-surface paper ejection tray 150.

Image forming apparatus 100 of this example is also provided with two-dimensional sensor 170 as an imaging section for imaging an object placed on object placement platform 160. In image forming apparatus 100 of this example, two-dimensional sensor 170 is configured by providing a two-dimensional arrangement of CCD (Charge Coupled Device), CMOS (Complementary Metal Oxide Semiconductor), or suchlike image sensors capable of reading a photographic image of a sheet document, a book or similar bound document, a three-dimensional object, and so forth.

Two-dimensional sensor 170 in image forming apparatus 100 of this example is positioned on top-surface paper ejection tray 150 so that an imaging surface 170a is opposite object placement surface 161 of object placement platform 160 by rotation on fulcrum 171.

Referring to FIG. 3, when an image is formed on paper P fed by paper feed unit 120, an image forming process by means of the well-known electrophotographic method is performed around photosensitive drum 111.

In image forming apparatus 100 of this example, the surface of photosensitive drum 111 is first charged to approximately −700 V by means of electrifier 113. Then the surface of photosensitive drum 111 is radiated with a laser beam by laser optical unit 112 serving as an exposure apparatus, and an electrostatic latent image is formed in accordance with input image information.

When an electrostatic latent image is written to photosensitive drum 111 by laser optical unit 112, the surface potential of exposed image areas is diselectrified to approximately −100 V or below.

Meanwhile, the charge of toner present on magnet roller 114a of developing unit 114 is generally on the order of −20 to −30 μC/g. In this developing unit 114, development is executed by applying AC+DC development voltages, with figures of 4 kHz and 1.6 kVpp for AC and approximately −250 V for DC.

By this means, a toner image is formed by the adhesion of toner to exposed image areas on photosensitive drum 111 which has been diselectrified to approximately −100 V or below.

Following this, the toner image formed on photosensitive drum 111 is transferred by transfer roller 115 to paper P which has been charged to approximately +500 V.

Then, when paper P crosses fixing unit 117, the toner image adhering to paper P is first melted by the application of heat and pressure, and then fixed to paper P.

Paper P on which the toner image has been fixed is then ejected onto, and stacked on, top-surface paper ejection tray 150 by top-surface paper ejection rollers 132 of top-surface paper ejection unit 130.

When object reading (object imaging) is not performed by two-dimensional sensor 170, image forming is performed with top-surface paper ejection tray 150 in a closed state, as shown in FIG. 2 and FIG. 3.

On the other hand, when an object is imaged by two-dimensional sensor 170, if, for example, reading of book B on object placement platform 160 is performed, image forming is performed with top-surface paper ejection tray 150 in an open state, as shown in FIG. 4 and FIG. 5.

In image forming apparatus 100 of this example, it is desirable for spindle 151 of top-surface paper ejection tray 150 to be installed parallel to top-surface paper ejection rollers 132 of top-surface paper ejection unit 130, and to be installed so that at least part of the top surface on which ejected paper P is placed near the spindle is lower than top-surface paper ejection aperture 133 provided at the top of apparatus body 101.

That is to say, with top-surface paper ejection tray 150 installed in this way, the ejection path of paper P ejected from top-surface paper ejection aperture 133 can be secured whether top-surface paper ejection tray 150 is in a closed state or an open state, and paper P can be ejected without becoming jammed when top-surface paper ejection tray 150 is opened or closed.

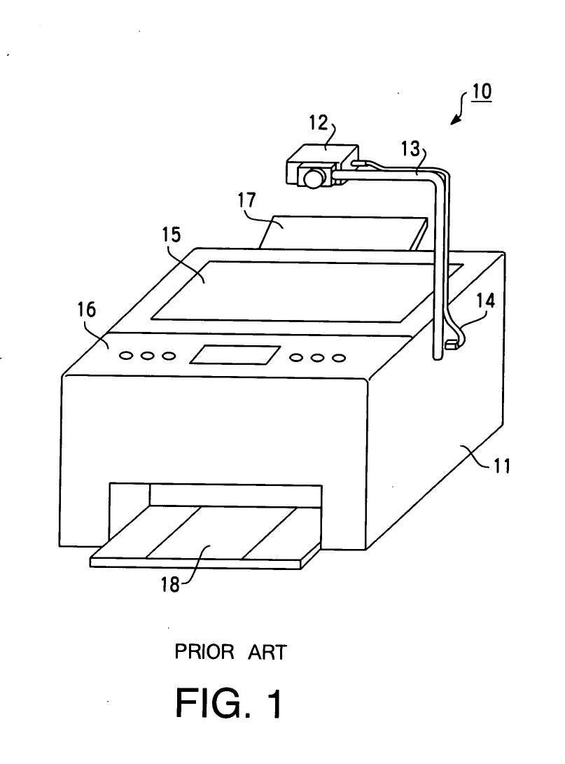

In image forming apparatus 100 of this example, since paper P on which an image has been formed is ejected onto top-surface paper ejection tray 150 located on the top of apparatus body 101, as described above, paper ejection section 18 does not project from one side of apparatus body 11 as in the case of conventional image forming apparatus 10 shown in FIG. 1, enabling the footprint of the apparatus to be made smaller, and an operation to remove ejected paper P can be performed easily.

Also, in image forming apparatus 100 of this example, since top-surface paper ejection tray 150 also functions as a support for two-dimensional sensor 170, which is the imaging section, it is not necessary to provide frame 13 extending above apparatus body 11 in order to secure digital camera 12 as in the case of conventional image forming apparatus 10 shown in FIG. 1, and the overall apparatus can be made more compact.

Next, the positional relationship between two-dimensional sensor 170 and top-surface paper ejection tray 150 and between two-dimensional sensor 170 and object placement platform 160, in image forming apparatus 100 of this example will be described.

As shown in FIG. 3 and FIG. 5, in image forming apparatus 100 of this example, two-dimensional sensor 170 is provided on the underside of top-surface paper ejection tray 150, and is installed so as to be shielded from the outside by top-surface paper ejection tray 150 and object placement platform 160 when top-surface paper ejection tray 150 is in a closed state with respect to apparatus body 101.

By this means, when top-surface paper ejection tray 150 is in a closed state with respect to apparatus body 101—that is, when two-dimensional sensor 170 is not used—two-dimensional sensor 170 can be protected from impacts from outside and infiltration of dust by top-surface paper ejection tray 150 and object placement platform 160.

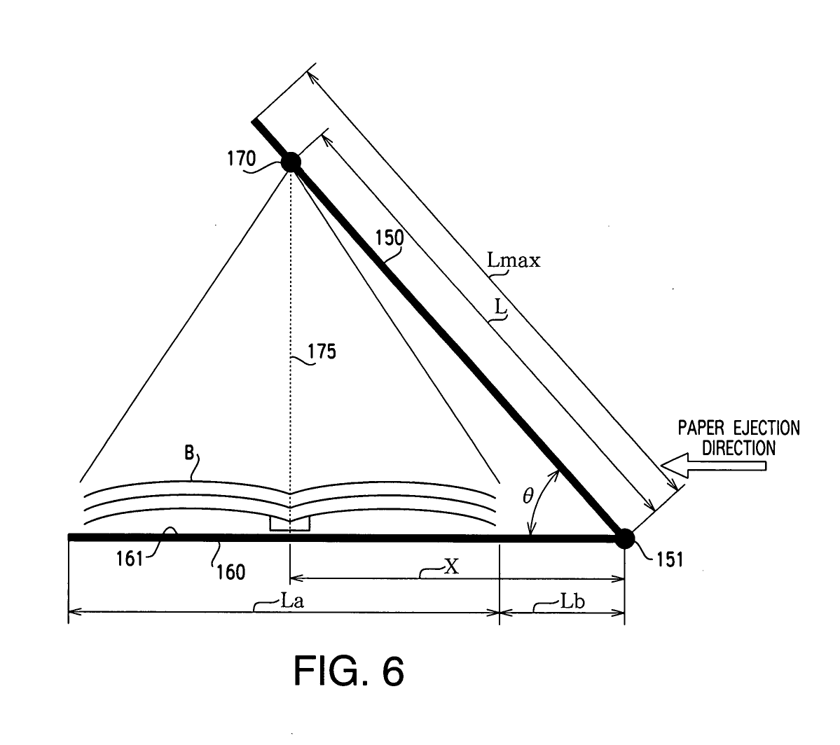

Also, in image forming apparatus 100 of this example, it is desirable for two-dimensional sensor 170 to be located inward from the edge of the side (the handle 152 side) opposite the spindle 151 side of the underside of top-surface paper ejection tray 150, as shown in FIG. 6. FIG. 6 is a schematic diagram for explaining the positional relationship between the two-dimensional sensor and the top-surface paper ejection tray and between the two-dimensional sensor and the object placement platform in the image forming apparatus according to Embodiment 1 of the present invention.

In FIG. 6, the relationship between the angle of opening θ of top-surface paper ejection tray 150 and the installation position of two-dimensional sensor 170 in image forming apparatus 100 of this example when imaging is performed is expressed by Equation (1) below.
cos θ=X/L (1)

In Equation (1), X is the distance from the fulcrum of top-surface paper ejection tray 150 (spindle 151) to the point of intersection of imaging optical axis 175 of two-dimensional sensor 170 and object placement surface 161 of object placement platform 160; L is the distance (tray length) from the fulcrum of top-surface paper ejection tray 150 (spindle 151) to the installation position (imaging center) of two-dimensional sensor 170; and θ is the angle of opening of top-surface paper ejection tray 150 with respect to object placement surface 161 of object placement platform 160 when imaging is performed by two-dimensional sensor 170.

If two-dimensional sensor 170 is installed so that its imaging optical axis 175 crosses the center of the possible imaging area on object placement surface 161 of object placement platform 160, an object placed on object placement surface 161 can be imaged from directly above with the least amount of distortion.

Thus, if {(La/2)+Lb} is substituted for distance X in above Equation (1), cos θ in Equation (1) can be expressed by Equation (2) below.
cos θ={(La/2)+Lb}/L (2)

In Equation (2), La is the imaging range width of the possible imaging area of two-dimensional sensor 170 on object placement surface 161 of object placement platform 160, and Lb is the non-imaging area width from spindle 151 of top-surface paper ejection tray 150 to the possible imaging area of two-dimensional sensor 170 on object placement surface 161 of object placement platform 160.

Incidentally, since, in image forming apparatus 100 of this example, paper P is ejected onto top-surface paper ejection tray 150 on which two-dimensional sensor 170 is installed, if angle of opening θ of top-surface paper ejection tray 150 is large, there is a risk of a paper jam occurring when paper P is ejected onto top-surface paper ejection tray 150.

While the occurrence of such paper P jams will vary depending on image forming conditions such as image forming apparatus 100 operating environment, the thickness of paper P, and the degree of curling of the front edge of paper P, they are envisaged as being prone to occur if top-surface paper ejection tray 150 angle of opening θ exceeds 50 degrees.

Therefore, in image forming apparatus 100 of this example, it is desirable for top-surface paper ejection tray 150 angle of opening θ to be set to 50 degrees or less (θ≦50 degrees). As a result, the value of cos θ in Equation (1) will be cos θ≧cos(50)≈0.64, and if the value of cos θ is substituted in Equation (2), Equation (2) can be expressed by Equation (3) below.
0.64≦{(La/2)+Lb}/L (3)

Based on such a condition, the positional relationship between two-dimensional sensor 170 and top-surface paper ejection tray 150 and between two-dimensional sensor 170 and object placement platform 160, in image forming apparatus 100 of this example, will be considered in concrete terms.

It is desirable for two-dimensional sensor 170 in image forming apparatus 100 of this example to be able to image objects up to A3 size width so as to conform to commonly used paper P sizes.

Also, since the perpendicular length of A3 size paper is 297 mm, it is desirable for possible imaging area imaging range width La of two-dimensional sensor 170 in image forming apparatus 100 of this example to be 300 mm, allowing for error.

Furthermore, since it is wished to make the overall size of image forming apparatus 100 of this example as compact as possible, it is desirable for non-imaging area width Lb on object placement surface 161 not to exceed 50 mm.

The present inventors then supposed it possible to satisfy all the above conditions by setting the installation position of two-dimensional sensor 170 not at the edge of top-surface paper ejection tray 150 opposite spindle 151 but inward from this edge of top-surface paper ejection tray 150, and shortening tray length L from spindle 151 to two-dimensional sensor 170.

If the above conditions are substituted in Equation (3), Equation (3) can be expressed by Equation (4) below.
0.64≦(150+50)/L (4)

If tray length L from spindle 151 to two-dimensional sensor 170 is found from Equation (4), tray length L is as shown in Equation (5) below.
L≦312.5 mm (5)

On the other hand, maximum tray length Lmax of top-surface paper ejection tray 150 (the tray length from spindle 151 to the edge of the side opposite the spindle 151 side) may have a width equal to the width of object placement surface 161 of object placement platform 160.

That is to say, since the width of object placement surface 161 of object placement platform 160 is the sum of the imaging range width La of the possible imaging area of two-dimensional sensor 170 and the non-imaging area width Lb on object placement surface 161, as shown in FIG. 6, maximum tray length Lmax of top-surface paper ejection tray 150 is given by Equation (6) below.
L max=La+Lb=350 mm (6)

From Equation (5) and Equation (6), the ratio of tray length L from spindle 151 to two-dimensional sensor 170 to maximum tray length Lmax of top-surface paper ejection tray 150 is given by Equation (7) below.
L/Lmax=312.5/350≈0.89 (7)

By this means, the present inventors found that, in order to make the overall apparatus compact, and prevent paper P jams and perform satisfactory imaging, it is desirable for two-dimensional sensor 170 in image forming apparatus 100 of this example to be installed inward by a proportion of at least ten percent of the overall length of top-surface paper ejection tray 150 from the edge opposite the spindle 151 side of top-surface paper ejection tray 150.

Thus, in image forming apparatus 100 of this example, tray length L from spindle 151 to two-dimensional sensor 170 on top-surface paper ejection tray 150 is set so that L≦0.9×Lmax, and preferably, 0.7×Lmax≦L≦0.9×Lmax.

When a case is considered in which two-dimensional sensor 170 is installed at the edge of top-surface paper ejection tray 150 opposite the spindle 151 side under the above conditions, tray length L from spindle 151 to two-dimensional sensor 170 on top-surface paper ejection tray 150 is the sum of possible imaging area imaging range width La of two-dimensional sensor 170 on object placement surface 161 and non-imaging area width Lb (La+Lb). Therefore, cos θ in Equation (2) is given by Equation (8) below.
cos θ={(La/2)+Lb}/(La+Lb)={(300/2)+50}/(300+50)=4/7 (8)

Therefore, when two-dimensional sensor 170 is installed at the opposite edge of top-surface paper ejection tray 150 from the spindle 151 side, angle of opening θ of top-surface paper ejection tray 150 with respect to object placement surface 161 of object placement platform 160 when imaging is performed by two-dimensional sensor 170 is approximately 57 degrees.

Thus, when two-dimensional sensor 170 is installed at the opposite edge of top-surface paper ejection tray 150 from the spindle 151 side, angle of opening θ of top-surface paper ejection tray 150 is greater than 50 degrees, and, as stated above, paper P jams are envisaged as being prone to occur. It can thus be seen that this kind of installation of two-dimensional sensor 170 is undesirable.

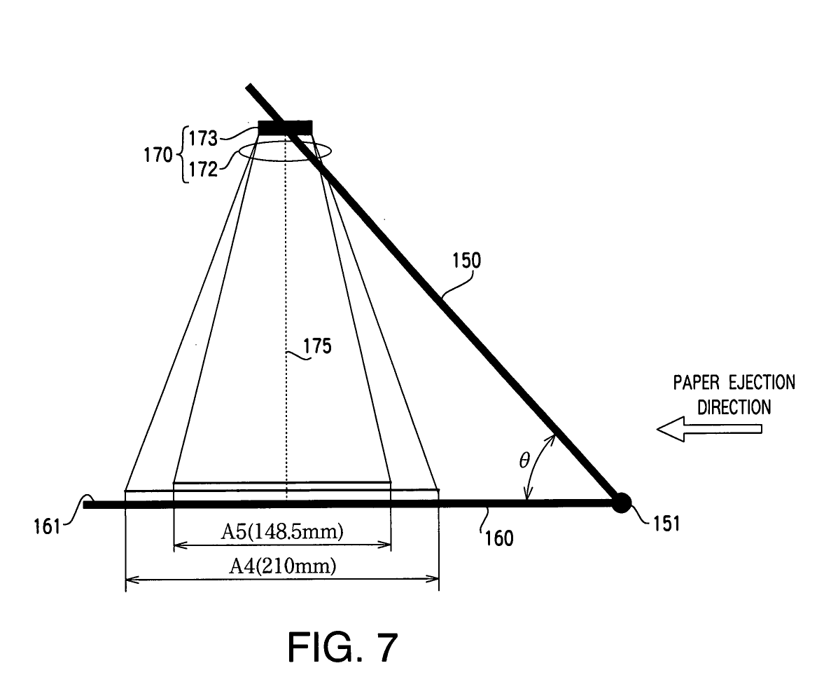

Next, the imaging position of two-dimensional sensor 170 with respect to an object in image forming apparatus 100 of this example will be described. FIG. 7 is a schematic diagram for explaining the imaging position of a two-dimensional sensor with respect to an object in an image forming apparatus according to Embodiment 1 of the present invention. In FIG. 7, an image of an object placed on object placement surface 161 of object placement platform 160 is formed on charge coupled device (CCD) 173 via an imaging lens 172 of two-dimensional sensor 170.

In image forming apparatus 100 of this example, when imaging of an object placed on object placement surface 161 of object placement platform 160 is performed, it is desirable for two-dimensional sensor 170 to be positioned on a vertical line crossing the center of the possible imaging area of object placement surface 161, irrespective of the size of the object.

That is to say, it is desirable for two-dimensional sensor 170 in image forming apparatus 100 of this example to be installed so that its imaging optical axis 175 crosses the center of the possible imaging area of object placement surface 161, as shown in FIG. 7.

Image forming apparatus 100 configured so that imaging optical axis 175 of two-dimensional sensor 170 crosses the center of the possible imaging area on object placement surface 161 in this way enables an object placed on object placement surface 161 to be imaged from directly above with the least amount of distortion.

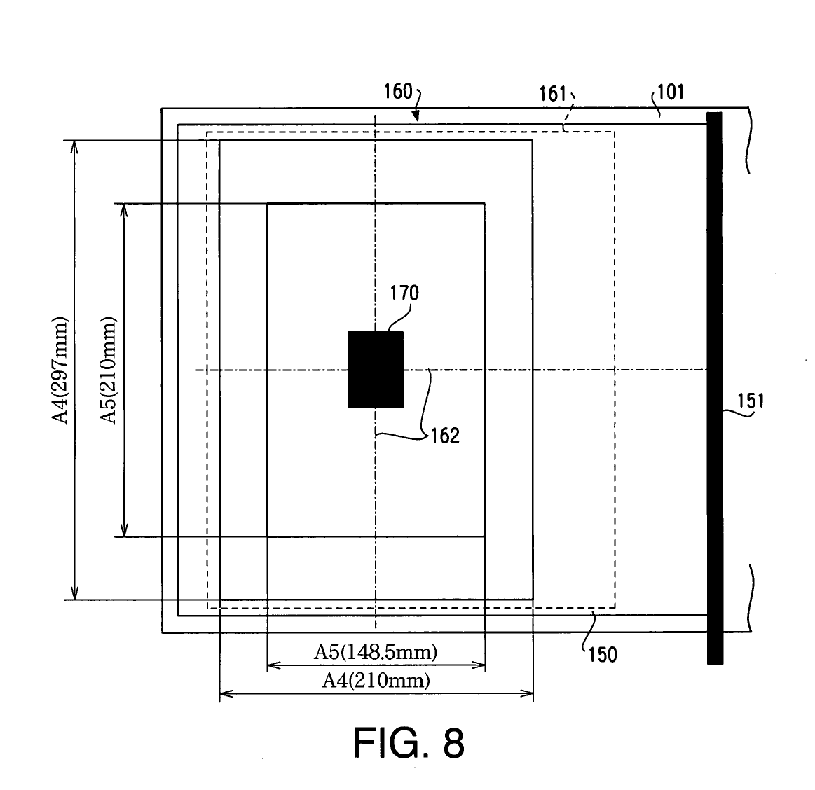

Next, the placement reference position of an object with respect to object placement surface 161 of object placement platform 160 in image forming apparatus 100 of this example will be described. FIG. 8 is a schematic diagram for explaining the placement reference position of an object with respect to the object placement surface of the object placement platform in an image forming apparatus according to Embodiment 1 of the present invention.

As shown in FIG. 8, object placement platform 160 in image forming apparatus 100 of this example has object placement reference position marks 162 that indicate the reference position when an object is placed on object placement surface 161 of object placement platform 160.

Object placement reference position marks 162 of object placement platform 160 in image forming apparatus 100 are set with the imaging position (imaging optical axis 175) of two-dimensional sensor 170 when imaging of an object is performed as a reference.

By this means, as shown in FIG. 8, imaging optical axis 175 of two-dimensional sensor 170 crosses the center of the possible imaging area on object placement surface 161, and an object placed on object placement surface 161 can be imaged from directly above with the least amount of distortion.

### Embodiment 2

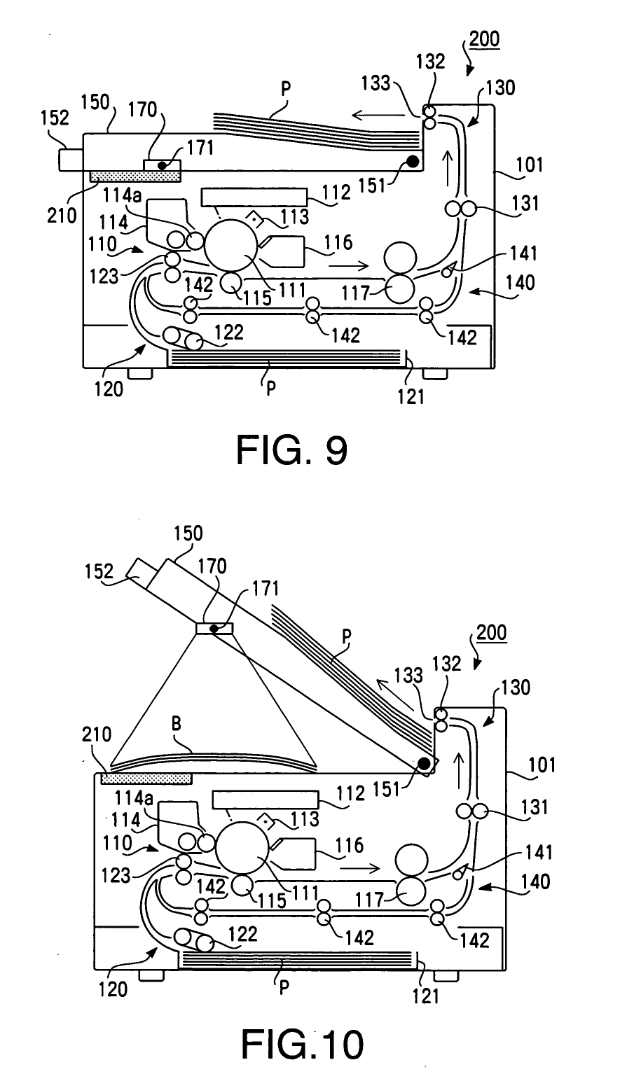

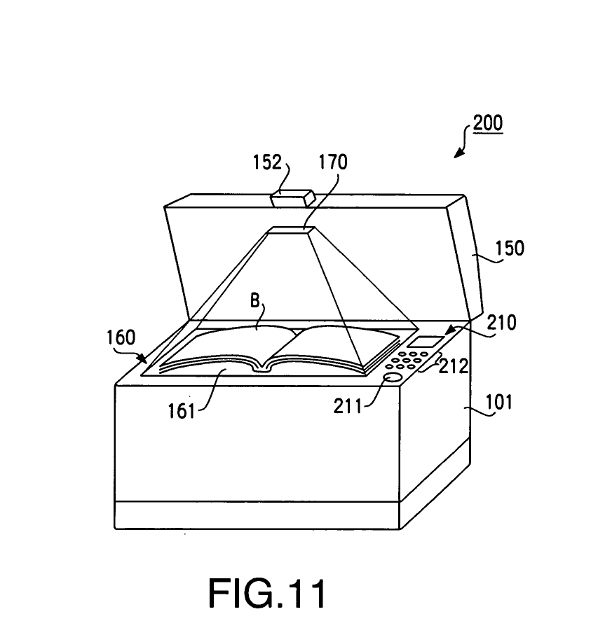

An image forming apparatus according to Embodiment 2 of the present invention will now be described with reference to FIG. 9, FIG. 10, and FIG. 11. FIG. 9 is a schematic configuration diagram showing the configuration of an image forming apparatus according to Embodiment 2 of the present invention with the top-surface paper ejection tray in a closed state, FIG. 10 is a schematic configuration diagram showing the configuration of an image forming apparatus according to Embodiment 2 of the present invention with the top-surface paper ejection tray in an open state, and FIG. 11 is a schematic oblique drawing showing the outward appearance of an image forming apparatus according to Embodiment 2 of the present invention with the top-surface paper ejection tray in an open state.

In order to reduce the footprint, many image forming apparatuses such as MFP employ a configuration in which an operating section (operation panel), equipped with a copy button, numeric keypad, and so forth operated by an operator, is provided on a projecting section formed so as to project forward or sideways from the upper part of the body of the apparatus.

The copy button, numeric keypad, and so forth of this kind of operating section are mainly used in copy mode in which a hard copy is made of a document image, and are not used in print mode in which, for example, RGB image data stored in an external computer or the like is read and used for image forming (printout by the print section) by the image forming unit of the apparatus.

However, with an image forming apparatus configured with the operating section projecting from the body of the apparatus as described above, there is a risk of the copy button being pressed by mistake in print mode, and of image forming being executed unintentionally and unnecessarily.

Furthermore, with an image forming apparatus configured in this way, since the appearance (design) features a section projecting from the body of the apparatus, if the cubic capacity of packaging is decreased and the amount of cushioning material is reduced, there is a risk of damage to the operating section during shipment.

Therefore, with an image forming apparatus configured in this way, a box with a deceptively large cubic capacity is necessary for packaging, and a large amount of cushioning material is used to fill wasted empty space when the apparatus is shipped.

Thus, as shown in FIG. 9, FIG. 10, and FIG. 11, an image forming apparatus 200 of this example employs a configuration in which at least an operating section 210 operated by an operator when imaging is performed by two-dimensional sensor 170, the imaging section, is provided in an area covered by top-surface paper ejection tray 150 when in a closed state.

Specifically, as shown in FIG. 11, a configuration is employed in which copy button 211, numeric keypad 212, and so forth of operating section 210 are provided in an area of object placement platform 160 of apparatus body 101 and outside object placement surface 161 of object (here, book B).

As shown in FIG. 9, according to image forming apparatus 200 of this example, when top-surface paper ejection tray 150 is in a closed state, copy button 211, numeric keypad 212, and suchlike buttons of operating section 210 are covered by top-surface paper ejection tray 150.

Therefore, with image forming apparatus 200 of this example, when top-surface paper ejection tray 150 is closed and print mode is executed, there is no possibility of inadvertently pressing copy button 211, numeric keypad 212 buttons, or suchlike buttons of operating section 210 and executing image forming unintentionally and unnecessarily.

Also, since image forming apparatus 200 of this example has a clean design with no parts projecting from apparatus body 101, as shown in FIG. 9, there is no risk of damage to operating section 210 during shipment even if the cubic capacity of packaging is decreased and the amount of cushioning material is reduced.

Therefore, image forming apparatus 200 of this example can be packaged with a small amount of cushioning material using a box of cubic capacity close to its outward appearance with little wasted empty space at the time of packaging.

### Embodiment 3

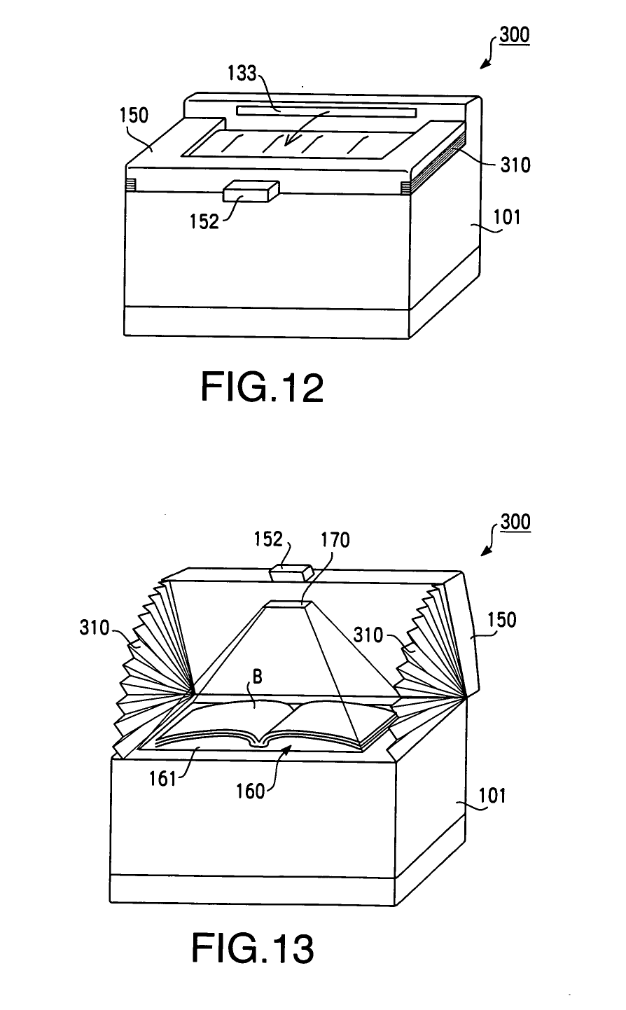

An image forming apparatus according to Embodiment 3 of the present invention will now be described with reference to FIG. 12 and FIG. 13. FIG. 12 is a schematic oblique drawing showing the outward appearance of an image forming apparatus according to Embodiment 3 of the present invention with the top-surface paper ejection tray in a closed state, and FIG. 13 is a schematic oblique drawing showing the outward appearance of an image forming apparatus according to Embodiment 3 of the present invention with the top-surface paper ejection tray in an open state.

With an image forming apparatus configured so that top-surface paper ejection tray 150 is opened and an object on object placement platform 160 is imaged, as described above, when top-surface paper ejection tray 150 is in an open state, large gaps are created between both sides of object placement platform 160 of apparatus body 101 and top-surface paper ejection tray 150, as shown in FIG. 4 and FIG. 11.

Therefore, with an image forming apparatus configured in this way, there is a risk of an object placed on object placement platform 160 being read by a third party through the gaps between both sides of object placement platform 160 and top-surface paper ejection tray 150.

When, for example, an object (document) placed on object placement platform 160 contains personal or confidential information, unforeseen detrimental effects may result from leakage of that personal or confidential information to a third party.

Also, with an image forming apparatus configured in this way, if the configuration provides for an object placed on object placement platform 160 to be illuminated, there is a risk of light leaking from the gaps between both sides of object placement platform 160 and top-surface paper ejection tray 150, and having an unpleasant effect on the surroundings.

Thus, as shown in FIG. 12 and FIG. 13, an image forming apparatus 300 of this example employs a configuration in which pleated (bellows-type) screening members 310 are provided between object placement platform 160 and top-surface paper ejection tray 150 to screen the gaps between both sides of object placement platform 160 and top-surface paper ejection tray 150 when top-surface paper ejection tray 150 is in an open state.

By this means, with image forming apparatus 300 of this example, when top-surface paper ejection tray 150 is opened, the gaps between both sides of object placement platform 160 and top-surface paper ejection tray 150 of apparatus body 101 are covered by pleated screening members 310.

Therefore, with image forming apparatus 300 of this example, there is little possibility of an object placed on object placement platform 160 being read by a third party, and security when imaging is performed by means of two-dimensional sensor 170 is improved.

Also, with image forming apparatus 300 of this example, even if the configuration provides for an object placed on object placement platform 160 to be illuminated, light that might leak from the gaps between both sides of object placement platform 160 and top-surface paper ejection tray 150 can be screened by pleated screening members 310, and there is little risk of the surroundings being unpleasantly affected by leaked light.

Furthermore, with image forming apparatus 300 of this example, the impact of closing top-surface paper ejection tray 150 can be lessened by pleated screening members 310 provided between object placement platform 160 and top-surface paper ejection tray 150.

Moreover, with image forming apparatus 300 of this example, vibration of top-surface paper ejection tray 150 in an open state can be suppressed by pleated screening members 310 provided between object placement platform 160 and top-surface paper ejection tray 150.

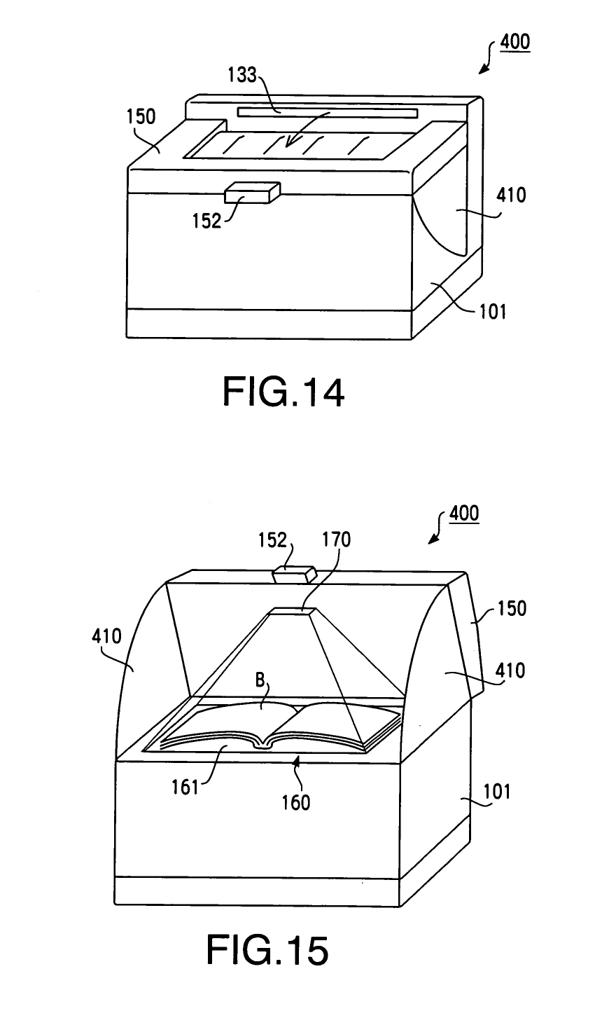

In image forming apparatus 300 shown in FIG. 12 and FIG. 13, pleated screening members 310 are used to screen the gaps between both sides of object placement platform 160 and top-surface paper ejection tray 150, but fan-shaped screening sheets 410 may also be used as screening members that screen the gaps between both sides of object placement platform 160 and top-surface paper ejection tray 150, coupled with top-surface paper ejection tray 150 opening and closing operations, as in image forming apparatus 400 shown in FIG. 14 and FIG. 15.

### Embodiment 4

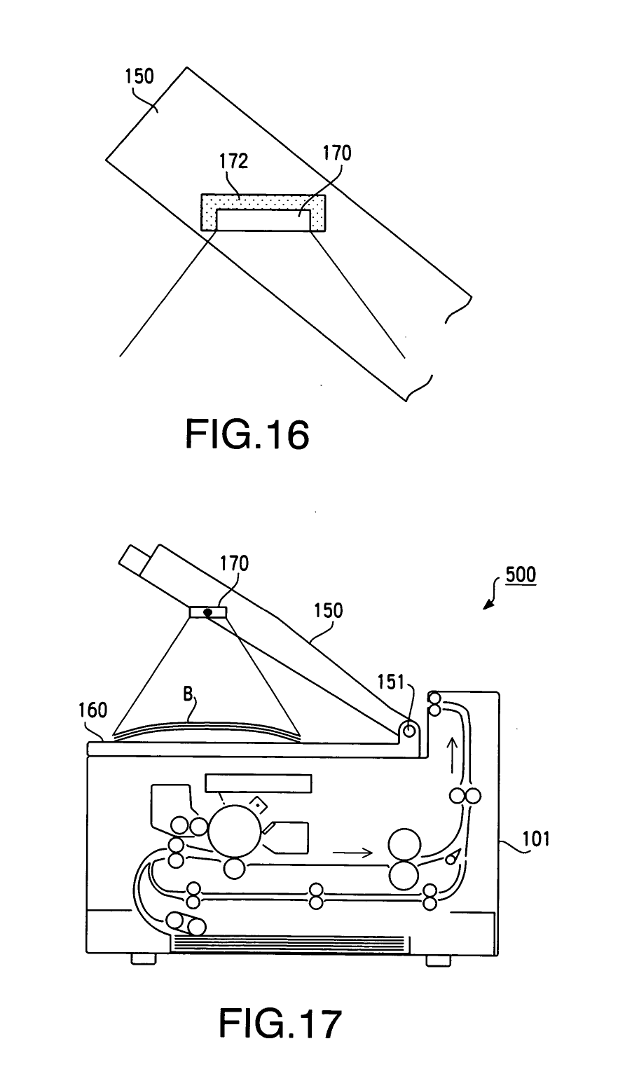

An image forming apparatus according to Embodiment 4 of the present invention will now be described with reference to FIG. 16. FIG. 16 is a schematic configuration diagram showing the configuration of essential parts of an image forming apparatus according to Embodiment 4 of the present invention.

In the above-described image forming apparatuses, since two-dimensional sensor 170 is installed on top-surface paper ejection tray 150 as an imaging section, vibration of apparatus body 101 that occurs during image forming and paper P ejection is readily transmitted to two-dimensional sensor 170 via top-surface paper ejection tray 150. Such vibration of two-dimensional sensor 170 may impede satisfactory imaging.

Also, with these image forming apparatuses 100, 200, 300, and 400, there is a risk of damage to two-dimensional sensor 170 if top-surface paper ejection tray 150 is closed forcefully.

It is therefore desirable for elastic material such as sponge or rubber, or a damping member such as a spring or damper, to be provided between the outer peripheral surface of two-dimensional sensor 170 and top-surface paper ejection tray 150 to prevent such vibration.

Thus, an image forming apparatus of this example employs a configuration in which vibration of two-dimensional sensor 170 is prevented by providing shock-absorbing member 172 of elastic material (sponge) as shown in FIG. 16.

According to an image forming apparatus of this example, transmission of vibration to two-dimensional sensor 170 of apparatus body 101 can be prevented by shock-absorbing member 172, enabling satisfactory imaging with little image blurring due to vibration to be achieved, and eliminating the risk of damage to two-dimensional sensor 170 in the event of forceful closing of top-surface paper ejection tray 150.

Image forming apparatus 500 shown in FIG. 17 employs a configuration in which spindle 151 of top-surface paper ejection tray 150 is provided on object placement platform 160, and top-surface paper ejection tray 150 is attached to object placement platform 160.

As a result of attaching top-surface paper ejection tray 150 to object placement platform 160 in this way, when vibration of apparatus body 101 is transmitted to object placement platform 160, object placement platform 160 and top-surface paper ejection tray 150 vibrate as an integral unit.

Therefore, with image forming apparatus 500 of this example, when apparatus body 101 vibrates, an object (book B) placed on object placement platform 160 and two-dimensional sensor 170 installed on top-surface paper ejection tray 150 vibrate as an integral unit, enabling image blurring due to vibration when imaging is performed by means of two-dimensional sensor 170 to be suppressed.

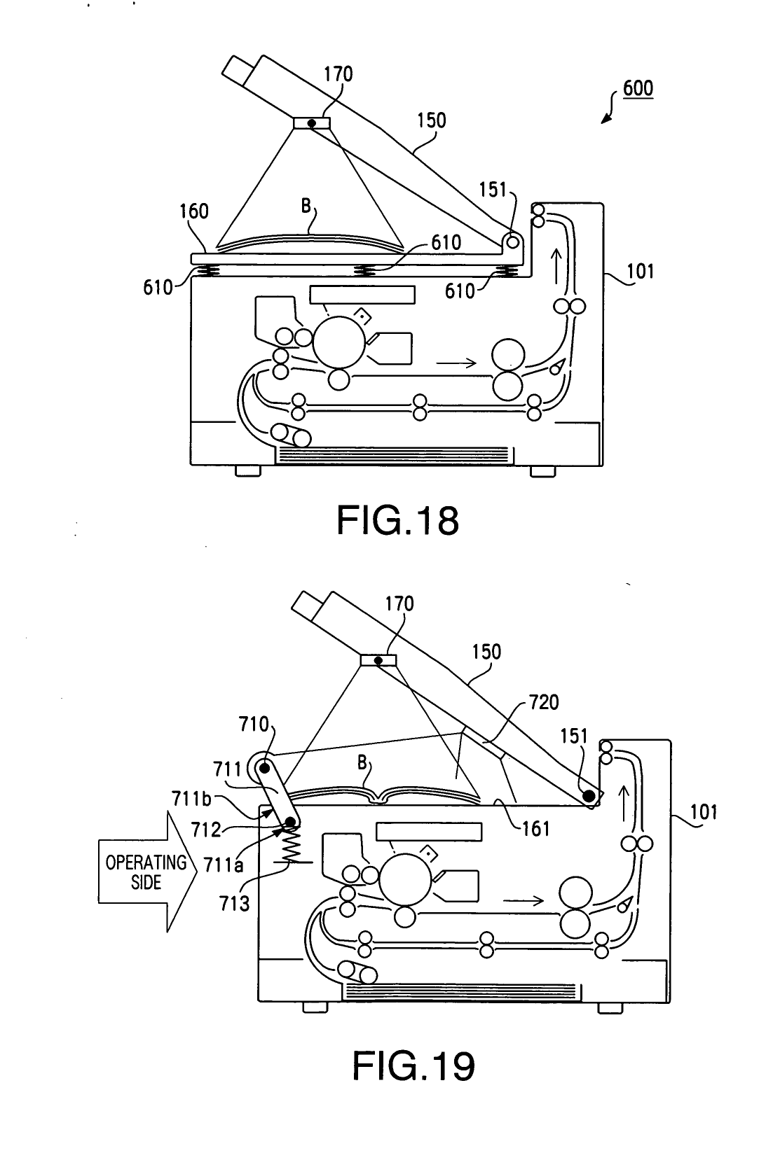

Image forming apparatus 600 shown in FIG. 18 employs a configuration in which spindle 151 of top-surface paper ejection tray 150 is provided on object placement platform 160 and top-surface paper ejection tray 150 is attached to object placement platform 160, and furthermore object placement platform 160 and apparatus body 101 are separated from each other, and vibration-isolating members 610 of damping material (springs) are provided between object placement platform 160 and apparatus body 101.

With image forming apparatus 600 of this example, since vibration-isolating members 610 are provided between object placement platform 160 and apparatus body 101, transmission of vibration from apparatus body 101 to two-dimensional sensor 170 can be prevented by vibration-isolating members 610, and image blurring due to vibration when imaging is performed by means of two-dimensional sensor 170 can be suppressed.

### Embodiment 5

An image forming apparatus according to Embodiment 5 of the present invention will now be described with reference to FIG. 19. FIG. 19 is a schematic configuration diagram showing the configuration of essential parts of an image forming apparatus according to Embodiment 5 of the present invention.

With an image forming apparatus configured so that object placement surface 161 of object placement platform 160 is exposed by pivoted movement of top-surface paper ejection tray 150, as described above, the brightness of object placement surface 161 on the pivoting side of top-surface paper ejection tray 150 (the area near spindle 151) tends to be lower than the brightness of object placement surface 161 on the side on which top-surface paper ejection tray 150 opens and closes.

Therefore, with an image forming apparatus configured in this way, there is a risk that, due to the decrease in brightness of object placement surface 161 on the pivoting side of top-surface paper ejection tray 150, the amount of exposure of the pivoting-side surface of an object placed on object placement surface 161 will be insufficient.

An effective way of eliminating this kind of partial insufficiency of exposure of the surface of an object is to illuminate an object placed on object placement surface 161 uniformly by means of light sources comprising a plurality of LEDs, halogen lamps, or the like.

However, when an object placed on object placement surface 161 is illuminated uniformly by a plurality of light sources, a “highlights losing” phenomenon may occur whereby reflected light of the light sources shone on the surface of the object strikes two-dimensional sensor 170, causing an image in which part of the captured image is whited-out.

Also, when an object is illuminated uniformly by a plurality of light sources, depending on the location of the light sources, light from the light sources may shine directly in the eyes of the operator and make operation of the object and so forth difficult.

Thus, as shown in FIG. 19, an image forming apparatus 700 of this example employs a configuration in which light source 710 that illuminates an object (here, book B) is provided on the side where top-surface paper ejection tray 150 opens and closes (the side on which the operator performs operations), and a reflector (a mirror or similar object with a mirror-finished surface) 720 that reflects light emitted from light source 710 is mounted on the pivoting-side inner surface of top-surface paper ejection tray 150.

With image forming apparatus 700 of this example, since light source 710 that illuminates an object is provided on the side on which top-surface paper ejection tray 150 opens and closes, reflected light of light source 710 shone on an object placed on object placement surface 161 does not strike two-dimensional sensor 170, and the occurrence of the “highlights losing” phenomenon in a captured image can be eliminated.

Also, with image forming apparatus 700 of this example, since light source 710 that illuminates an object is provided on the side on which top-surface paper ejection tray 150 opens and closes, light from light source 710 does not shine directly in the eyes of the operator and make operation of the object and so forth difficult.

Furthermore, with image forming apparatus 700 of this example, since reflector 720 that reflects light emitted from light source 710 is mounted on the pivoting-side inner surface of top-surface paper ejection tray 150, insufficiency of the amount of exposure of the pivoting-side surface of an object placed on object placement surface 161 can be eliminated.

Light source 710 may also be configured so as to be movable, in order to facilitate the operation of placing an object on object placement platform 160. Specifically, for example, light source 710 may be linked to apparatus body 101 via linking plate 711. One end of linking plate 711 is attached to apparatus body 101 so as to be able to rotate about linkage spindle 712, and the other end of linking plate 711 supports light source 710. When light source 710 is pushed upward manually after top-surface paper ejection tray 150 has been opened in order to perform imaging of an object and the object has been placed on object placement surface 161, linking plate 711 is locked by the application of force to flat surface 711a of linking plate 711 by linking plate 711 securing spring 713, and light source 710 is set in a predetermined position. After imaging is finished, when light source 710 is pushed downward, linking plate securing spring 713 applies force to another flat surface 711b of linking plate 711, linking plate 711 is locked, and light source 710 is set in a predetermined position.

In the above example, manual operation has been described as the method of moving light source 710, but it is also possible to attach a gear wheel to linkage spindle 712, and set light source 710 in a predetermined position by rotating linkage spindle 712 by means of a motor or suchlike drive source.

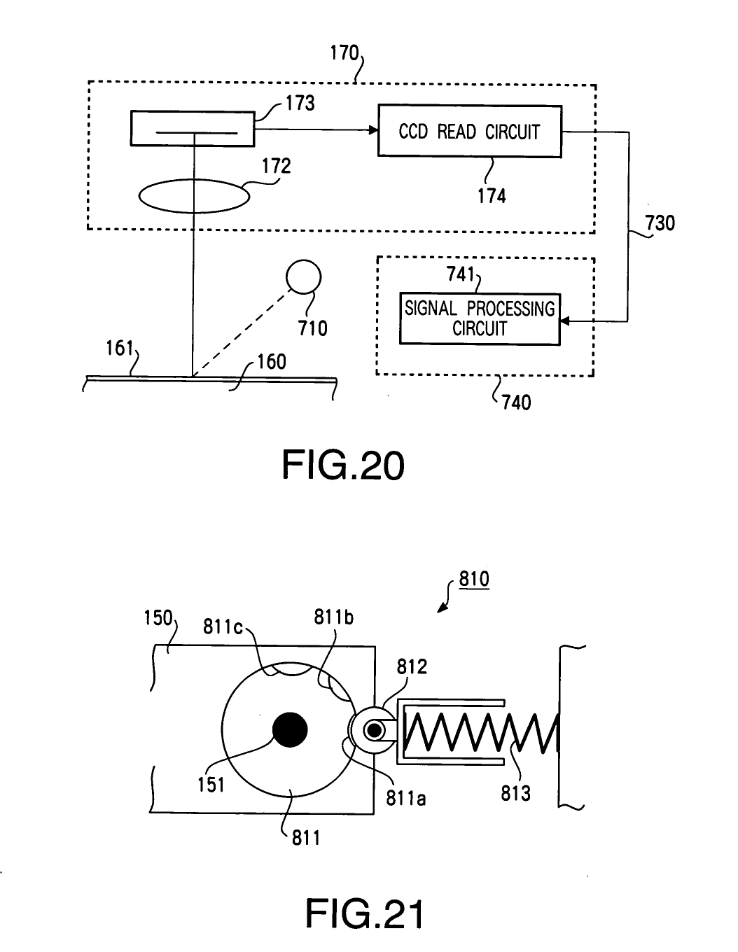

FIG. 20 is a block diagram for explaining the image signal flow in an image forming apparatus according to Embodiment 5 of the present invention.

In FIG. 20, light source 710 illuminates an object placed on object placement surface 161 of object placement platform 160. An image of the object is captured by charge coupled device (CCD) 173 via imaging lens 172 of two-dimensional sensor 170.

A signal output from CCD 173 of two-dimensional sensor 170 is read by CCD read circuit 174, and is sent to signal processing circuit 741 of an image processing section 740 via connecting cable 730. CCD read circuit 174 is provided with a shading correction circuit for correcting unevenness of illumination of object placement surface 161 on object placement platform 160 by light source 710.

### Embodiment 6

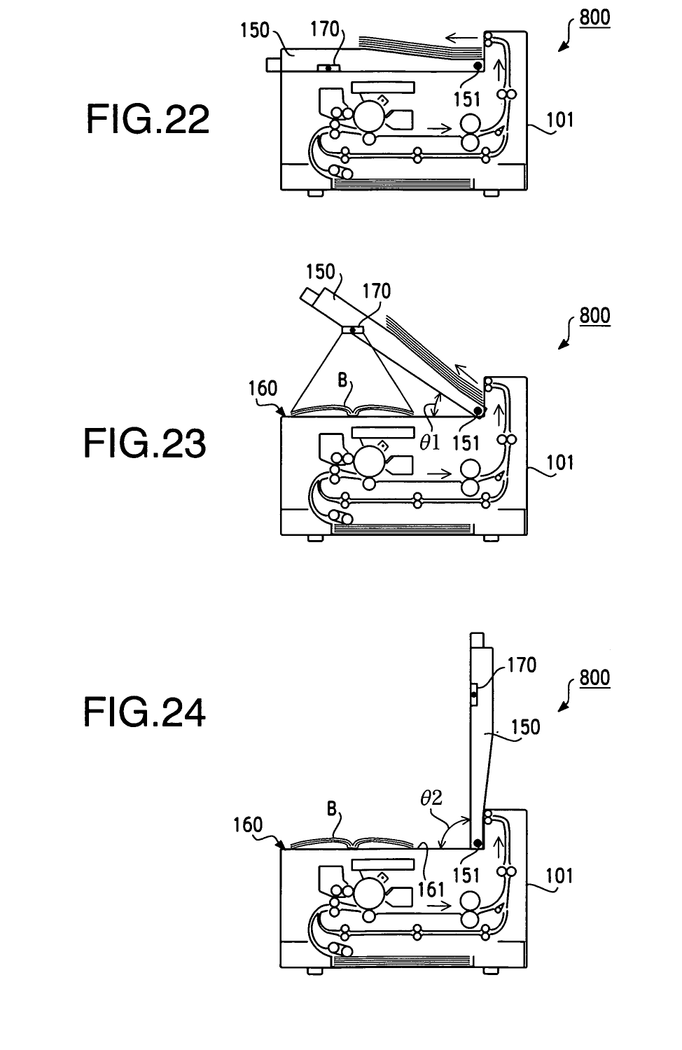

An image forming apparatus according to Embodiment 6 of the present invention will now be described with reference to FIG. 21, FIG. 22, FIG. 23, and FIG. 24. FIG. 21 is a schematic configuration diagram showing the configuration of the supporting member of the top-surface paper ejection tray in an image forming apparatus according to Embodiment 6 of the present invention, FIG. 22 is a schematic drawing showing the top-surface paper ejection tray of an image forming apparatus according to Embodiment 6 of the present invention in a closed state, FIG. 23 is a schematic drawing showing the top-surface paper ejection tray of an image forming apparatus according to Embodiment 6 of the present invention opened to the imaging position, and FIG. 24 is a schematic drawing showing the top-surface paper ejection tray of an image forming apparatus according to Embodiment 6 of the present invention opened to the maximum extent.

As described above, in an image forming apparatus with a configuration in which an object on object placement platform 160 is imaged by two-dimensional sensor 170 installed on top-surface paper ejection tray 150 that can be opened and closed, the installation position of two-dimensional sensor 170 on top-surface paper ejection tray 150, and the angle of opening of top-surface paper ejection tray 150, are set so that two-dimensional sensor 170 is positioned above the center of object placement surface 161 when object imaging is performed.

While varying somewhat according to the installation position of two-dimensional sensor 170, the angle of opening of top-surface paper ejection tray 150 when object imaging is performed is the angle by which top-surface paper ejection tray 150 is inclined with respect to object placement surface 161, as shown in FIG. 5 for example.

Therefore, a problem with an image forming apparatus configured in this way is that it is difficult to perform an operation of placing an object on object placement platform 160 while top-surface paper ejection tray 150 is inclined with respect to object placement surface 161 as described above.

Thus, an image forming apparatus of this example has a configuration provided with a tray latching section that latches top-surface paper ejection tray 150 at a plurality of angles of opening, comprising at least a first angle of opening θ1 at which an object placed on object placement platform 160 is imaged by two-dimensional sensor 170, and a second angle of opening θ2 that is greater than first angle of opening θ1.

FIG. 21 is a schematic configuration diagram showing the configuration of a tray latching section in an image forming apparatus of this example.

As shown in FIG. 21, tray latching section 810 in an image forming apparatus of this example is provided with disk 811 that has spindle 151 of top-surface paper ejection tray 150 as its center of rotation, and rotates linked to opening and closing operations of top-surface paper ejection tray 150.

On the periphery of disk 811 are three recesses 811a, 811b, and 811c, and click-stopper 812 that engages with each of recesses 811a, 811b, and 811c is pressed into contact with recesses 811a, 811b, and 811c by the elastic force of tensile coil spring 813.

When top-surface paper ejection tray 150 of an image forming apparatus 800 of this example is in a closed state, click-stopper 812 engages with recess 811a, and top-surface paper ejection tray 150 is latched in the closed position, as shown in FIG. 22.

When an object (book B) placed on object placement platform 160 is to be imaged by two-dimensional sensor 170, click-stopper 812 engages with recess 811b as a result of top-surface paper ejection tray 150 being opened, and top-surface paper ejection tray 150 is latched at first angle of opening θ1 (approximately 30 degrees), as shown in FIG. 23.

Furthermore, with image forming apparatus 800 of this example, when an object (book B) is placed on object placement platform 160, click-stopper 812 engages with recess 811c as a result of top-surface paper ejection tray 150 being opened widely, and top-surface paper ejection tray 150 is latched at second angle of opening θ2 (approximately 90 degrees), as shown in FIG. 24.

Thus, with image forming apparatus 800 of this example, top-surface paper ejection tray 150 can be latched at second angle of opening θ2 at which top-surface paper ejection tray 150 is opened widely, enabling an operation of placing an object on object placement platform 160 to be performed easily.

### Embodiment 7

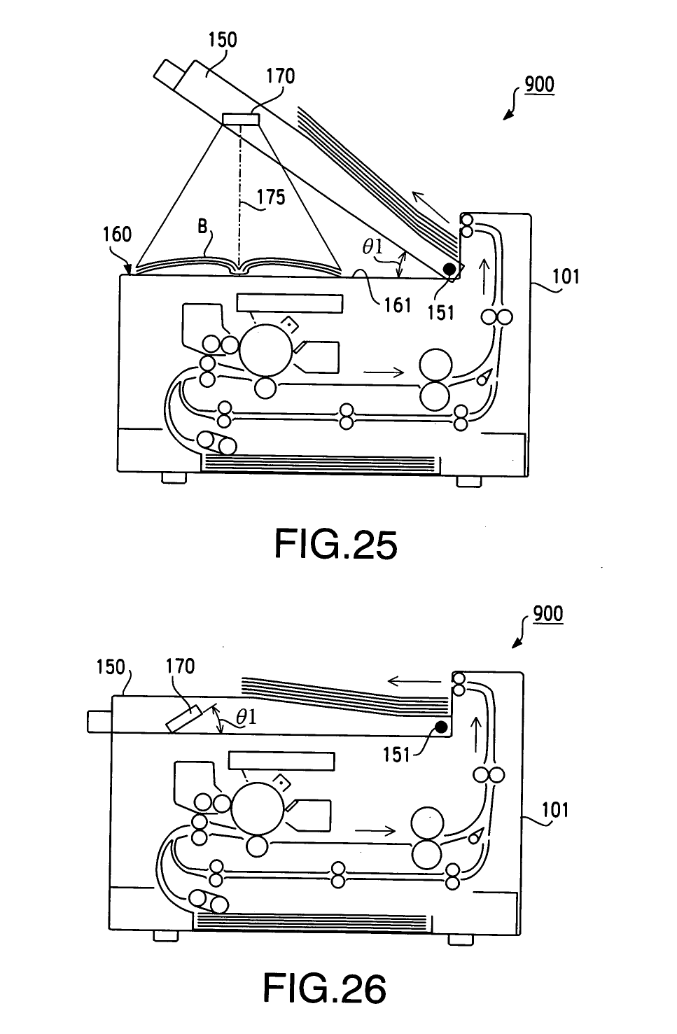

An image forming apparatus according to Embodiment 7 of the present invention will now be described with reference to FIG. 25 and FIG. 26. FIG. 25 is a schematic drawing showing the top-surface paper ejection tray of an image forming apparatus according to Embodiment 7 of the present invention in an open state, and FIG. 26 is a schematic drawing showing the top-surface paper ejection tray of an image forming apparatus according to Embodiment 7 of the present invention in a closed state.

In the above-described embodiments, in order to facilitate the operation of imaging an object placed on object placement platform 160, it is desirable for two-dimensional sensor 170 to be placed in a state in which it can perform object imaging immediately simply by opening top-surface paper ejection tray 150 to the imaging position at first angle of opening θ1 shown in FIG. 23, for example.

Thus, as shown in FIG. 25, an image forming apparatus 900 of this example employs a configuration in which two-dimensional sensor 170 is fixed to top-surface paper ejection tray 150 so that, when top-surface paper ejection tray 150 is opened to the first angle of opening θ1, two-dimensional sensor 170 is placed in a position and attitude for imaging an object placed on object placement platform 160.

Specifically, two-dimensional sensor 170 is fixed to top-surface paper ejection tray 150 so that, when top-surface paper ejection tray 150 is opened to the imaging position at first angle of opening θ1, imaging optical axis 175 of two-dimensional sensor 170 becomes orthogonal to object placement surface 161 of object placement platform 160.

That is to say, in image forming apparatus 900 of this example, two-dimensional sensor 170 is fixed at an inclination of angle θ1 with respect to top-surface paper ejection tray 150 when top-surface paper ejection tray 150 is in a closed state, as shown in FIG. 26.

By fixing two-dimensional sensor 170 to top-surface paper ejection tray 150 so as to be in a position and attitude for imaging in this way, it is possible for an object placed on object placement platform 160 to be imaged immediately simply by opening top-surface paper ejection tray 150 to an open position corresponding to first angle of opening θ1.

### Embodiment 8

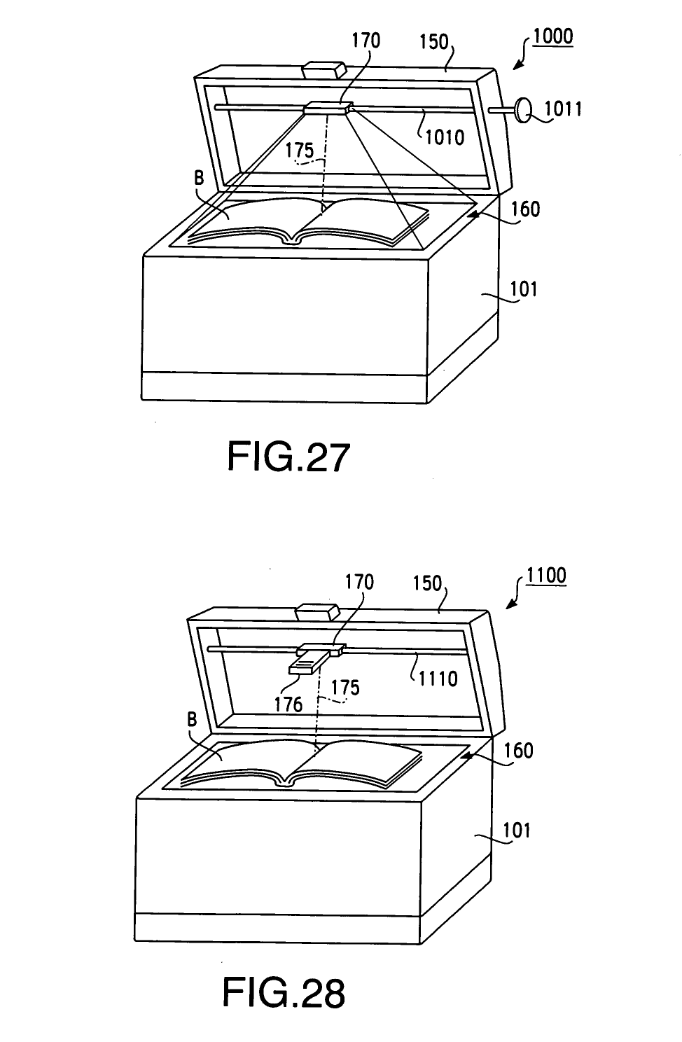

An image forming apparatus according to Embodiment 8 of the present invention will now be described with reference to FIG. 27. FIG. 27 is a schematic oblique drawing showing the outward appearance of an image forming apparatus according to Embodiment 8 of the present invention with the top-surface paper ejection tray in an open state.

When an object placed on object placement platform 160 is in sheet form, a configuration is desirable in which two-dimensional sensor 170 is fixed to top-surface paper ejection tray 150 so that imaging optical axis 175 of two-dimensional sensor 170 becomes orthogonal to object placement surface 161 when top-surface paper ejection tray 150 is opened to the imaging position, as in image forming apparatus 900 according to Embodiment 7.

However, when an object placed on object placement platform 160 is a three-dimensional object, it is also necessary to be able to image the object from a slanting direction in order to represent the three-dimensional characteristics of the object.

Thus, as shown in FIG. 27, image forming apparatus 1000 of this example has a configuration in which two-dimensional sensor 170 is attached to rotating spindle 1010 pivoted in top-surface paper ejection tray 150, and two-dimensional sensor 170 is supported in a freely rotatable fashion with respect to top-surface paper ejection tray 150.

According to image forming apparatus 1000 of this example, referring to FIG. 27, two-dimensional sensor 170 can be rotated by turning knob 1011 attached to one end of rotating spindle 1010, enabling an object (here book B) placed on object placement platform 160 to be imaged from a slanting direction.

Also, with image forming apparatus 1000 of this example, when imaging a sheet-type object, for example, even if top-surface paper ejection tray 150 has been opened to an arbitrary angle of opening, imaging optical axis 175 of two-dimensional sensor 170 can be adjusted so as to be orthogonal to the object by rotating two-dimensional sensor 170.

### Embodiment 9

An image forming apparatus according to Embodiment 9 of the present invention will now be described with reference to FIG. 28. FIG. 28 is a schematic oblique drawing showing the outward appearance of an image forming apparatus according to Embodiment 9 of the present invention with the top-surface paper ejection tray in an open state.

With an image forming apparatus such as a copier, if a document to be copied is a sheet of standard size, the placement position of the object (document) on object placement platform 160 is generally determined beforehand.

Therefore, with this kind of image forming apparatus, the operator usually considers that by placing the document to be copied in a predetermined position on object placement platform 160, a document image will be copied within the specified paper size.

However, when an object is imaged from above by means of two-dimensional sensor 170, as in the above-described embodiments, the image center of a document (object) placed on object placement platform 160 and the imaging center (imaging optical axis 175) of two-dimensional sensor 170 will not necessarily coincide, due to differences in paper size.

Thus, as shown in FIG. 28, image forming apparatus 1100 of this example has a configuration in which two-dimensional sensor 170 is attached, so as to be able to slide, to slide spindle 1110 fitted to top-surface paper ejection tray 150, and two-dimensional sensor 170 is supported so as to be free to move in a straight line with respect to top-surface paper ejection tray 150.

According to image forming apparatus 1100 of this example, referring to FIG. 28, two-dimensional sensor 170 can be moved in a straight line by being slid along slide spindle 1110, enabling the imaging center (imaging optical axis 175) of two-dimensional sensor 170 to be made to coincide with the image center of an object (here book B) placed on object placement platform 160.

Also, as shown in FIG. 28, image forming apparatus 1100 of this example is configured so that an operating lever 176 is attached to two-dimensional sensor 170, and two-dimensional sensor 170 can be slid along and rotated about slide spindle 1110 by operation of operating lever 176.

By this means, with image forming apparatus 1100 of this example, two-dimensional sensor 170 can be rotated by operation of operating lever 176, enabling an object (here book B) placed on object placement platform 160 to be imaged from a slanting direction, in a similar way to image forming apparatus 1000 according to Embodiment 8.

Also, with image forming apparatus 1100 of this example, when imaging a sheet-type object, for example, even if top-surface paper ejection tray 150 has been opened to an arbitrary angle of opening, imaging optical axis 175 of two-dimensional sensor 170 can be adjusted so as to be orthogonal to any position of the object by linearly moving and rotating two-dimensional sensor 170.

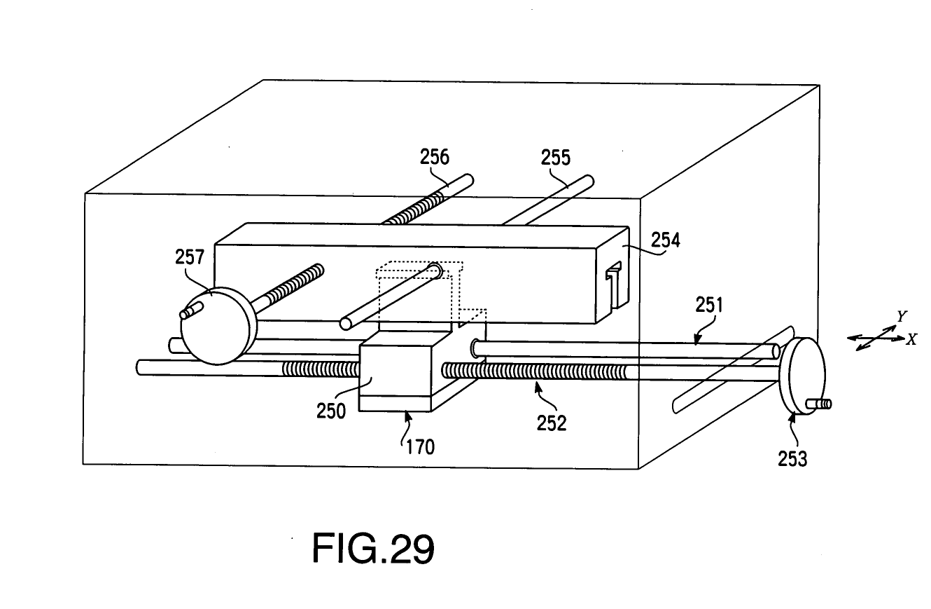

Although two-dimensional sensor 170 in image forming apparatus 1100 shown in FIG. 28 can only move in a straight line along slide spindle 1110, this two-dimensional sensor 170 may also be installed on the underside of an XY table 250 and made movable in two-dimensional directions, as shown in FIG. 29.

XY table 250 shown in FIG. 29 is supported by guide spindle 251 so as to be able to slide freely in the X direction. Ball screw 252 is fitted to XY table 250, and handle 253 is attached to one end of ball screw 252. XY table 250 is also supported by movable body 254 that can move freely in a straight line in the X direction.

Movable body 254 is supported by guide spindle 255 so as to be able to slide freely in the Y direction. Ball screw 256 is fitted to movable body 254, and handle 257 is attached to one end of ball screw 256.

Referring to FIG. 29, when handle 253 is turned, ball screw 252 rotates, and XY table 250 moves along guide spindle 251 and movable body 254 in the X direction.

On the other hand, again referring to FIG. 29, when handle 257 is turned, ball screw 256 rotates and movable body 254 moves along guide spindle 255 in the Y direction, and XY table 250 supported by movable body 254 also moves in the Y direction.

By this means, two-dimensional sensor 170 installed on the underside of XY table 250 can be moved in two-dimensional directions (the X and Y directions).

### Embodiment 10

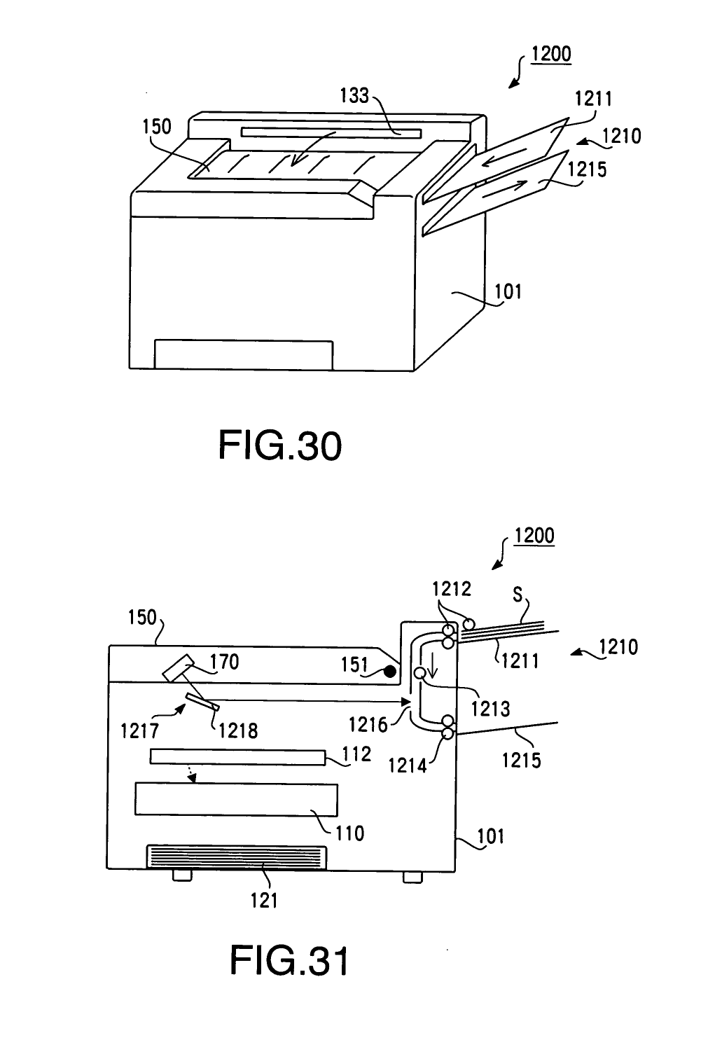

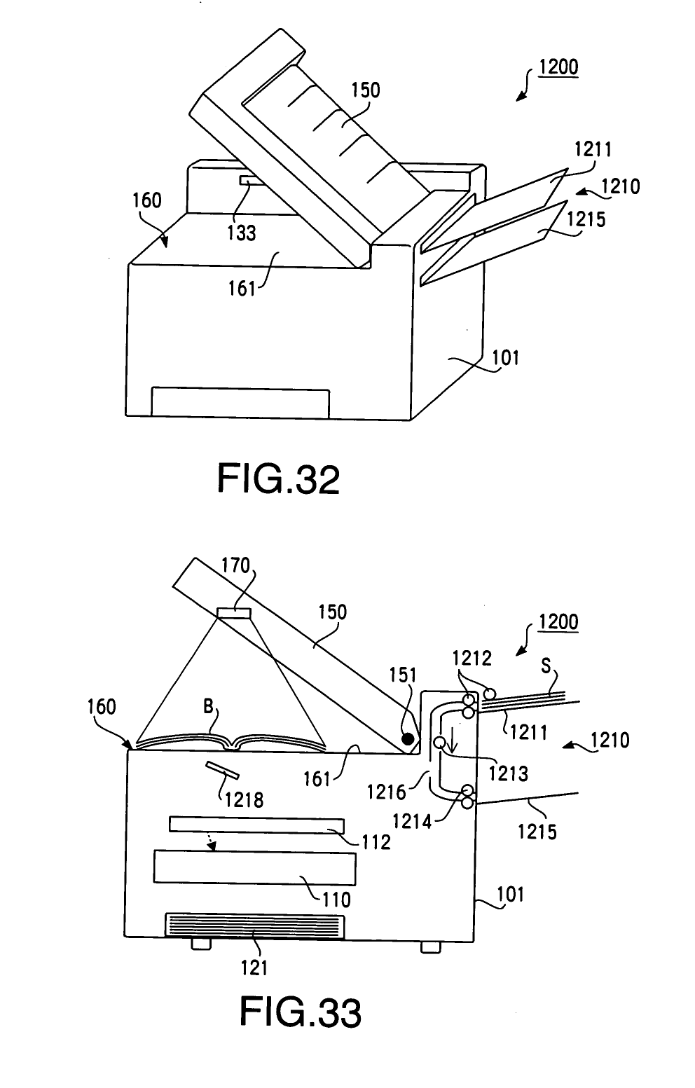

An image forming apparatus according to Embodiment 10 of the present invention will now be described with reference to FIG. 30, FIG. 31, FIG. 32, and FIG. 33. FIG. 30 is a schematic oblique drawing showing the outward appearance of an image forming apparatus according to Embodiment 10 of the present invention with the top-surface paper ejection tray in a closed state, FIG. 31 is a schematic configuration diagram showing the configuration of an image forming apparatus according to Embodiment 10 of the present invention with the top-surface paper ejection tray in a closed state, FIG. 32 is a schematic oblique drawing showing the outward appearance of an image forming apparatus according to Embodiment 10 of the present invention with the top-surface paper ejection tray in an open state, and FIG. 33 is a schematic configuration diagram showing the configuration of an image forming apparatus according to Embodiment 10 of the present invention with the top-surface paper ejection tray in an open state.

As shown in FIG. 30 and FIG. 31, image forming apparatus 1200 of this example is provided with an auto document feeder (ADF) 1210 that performs feeding of sheet-type documents (hereinafter referred to as “sheet documents”) S.

In image forming apparatus 1200 of this example, auto document feeder 1210 is composed of document feed tray 1211, document feed rollers 1212, document guide rollers 1213, document ejection rollers 1214, document ejection tray 1215, and so forth.

In FIG. 30 and FIG. 31, sheet documents S are stacked in document feed tray 1211. Sheet documents S stacked in document feed tray 1211 are separated and fed one sheet at a time by document feed rollers 1212.

Sheet document S separated and fed by document feed rollers 1212 is transported by document guide rollers 1213 to document information reading section 1216 that reads document information of a sheet document.

As shown in FIG. 31, image forming apparatus 1200 of this example has document reading optical system 1217 whereby document information of sheet document S transported to document information reading section 1216 is read by means of two-dimensional sensor 170.

In image forming apparatus 1200 of this example, document reading optical system 1217 is configured so that document information of sheet document S transported to document information reading section 1216 is read by two-dimensional sensor 170 fixed to top-surface paper ejection tray 150 in a closed state using reflecting mirror 1218.

By this means, in image forming apparatus 1200 of this example, document information of a plurality of sheet documents S can be read (scanned) successively by imaging two-dimensional sensor 170 while sheet document S top-surface paper ejection tray is in a closed state, without installation of a special-purpose scanner in auto document feeder 1210.

Sheet document S whose document information has been read by document information reading section 1216 is then ejected onto document ejection tray 1215 by document ejection rollers 1214.

As shown in FIG. 32 and FIG. 33, a document that cannot be fed by means of auto document feeder 1210 (such as book B, for example) is placed on object placement surface 161 of object placement platform 160 exposed by opening top-surface paper ejection tray 150, and imaged by two-dimensional sensor 170.

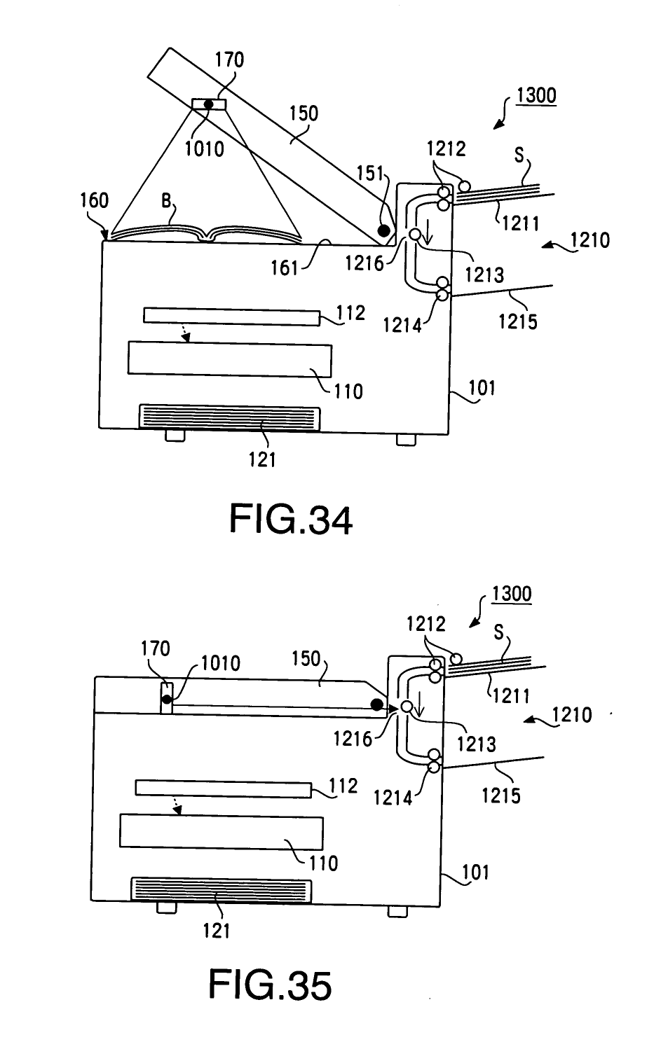

In image forming apparatus 1200, document information of sheet document S transported to document information reading section 1216 is read by two-dimensional sensor 170 fixed to top-surface paper ejection tray 150 in a closed state using reflecting mirror 1218, but provision may also be made for sheet document S document information to be read by two-dimensional sensor 170 installed on top-surface paper ejection tray 150 in a closed state so as to be able to rotate on rotating spindle 1010, as in image forming apparatus 1300 shown in FIG. 34 and FIG. 35.

In this image forming apparatus 1300, a document that cannot be fed by means of auto document feeder 1210 (such as book B, for example) is placed on object placement surface 161 of object placement platform 160 exposed by opening top-surface paper ejection tray 150, and imaged by two-dimensional sensor 170, as shown in FIG. 34.

Then, when document information of sheet document S transported to document information reading section 1216 of auto document feeder 1210 is read, two-dimensional sensor 170 installed on top-surface paper ejection tray 150 in a closed state is rotated to an attitude opposite document information reading section 1216, as shown in FIG. 35.

For example, this image forming apparatus 1300 may be configured so that two-dimensional sensor 170 is rotated through approximately 90 degrees about rotating spindle 1010 and latched by a rotating and latching section (not shown).

This image forming apparatus 1300 does not require document reading optical system 1217 used by image forming apparatus 1200 shown in FIG. 31, enabling the configuration to be simplified.

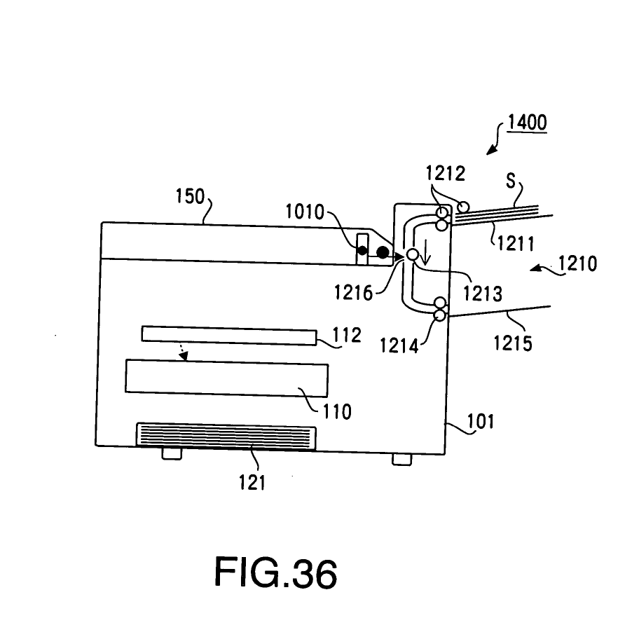

Two-dimensional sensor 170 in image forming apparatus 1300 is configured so as to be rotated on a fixed position about rotating spindle 1010, but provision may also be made for two-dimensional sensor 170 to be rotated to an attitude opposite document information reading section 1216 and moved to a reading position close to document information reading section 1216 by means of a moving and latching section (not shown), and there read document information of sheet document S, as in image forming apparatus 1400 shown in FIG. 36. Also, instead of a two-dimensional sensor, a one-dimensional sensor extending in a direction orthogonal to the direct of transportation of sheet document S may be used as the apparatus section that reads document information of sheet document S.

### Embodiment 11

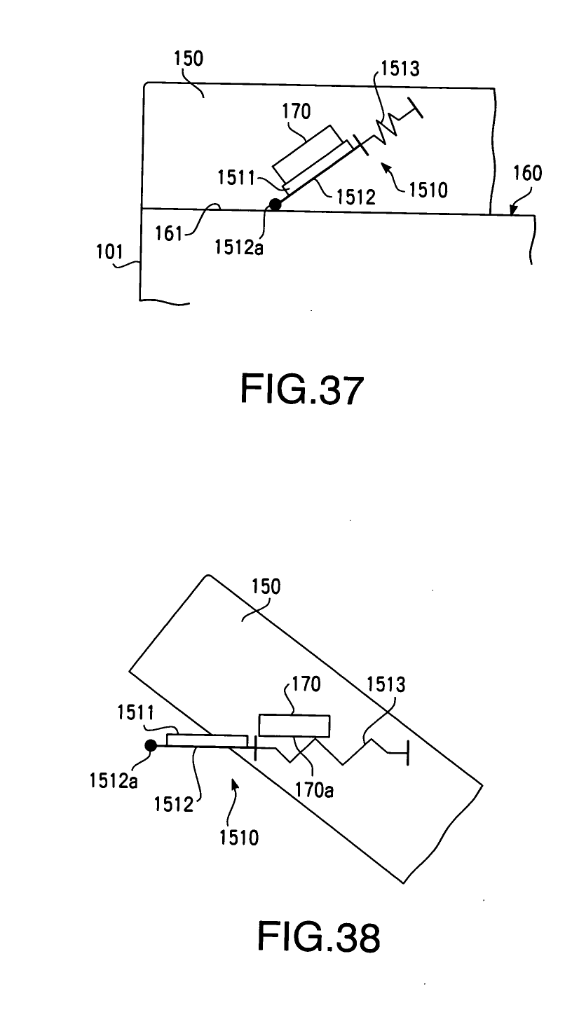

An image forming apparatus according to Embodiment 11 of the present invention will now be described with reference to FIG. 37 and FIG. 38. FIG. 37 is a schematic configuration diagram showing the configuration of an imaging section of an image forming apparatus according to Embodiment 11 of the present invention with the top-surface paper ejection tray in a closed state, and FIG. 38 is a schematic configuration diagram showing the configuration of an imaging section of an image forming apparatus according to Embodiment 11 of the present invention with the top-surface paper ejection tray in an open state.

A problem with two-dimensional sensor 170 serving as the above-described imaging section is that the quality of a captured image falls when imaging surface 170a is contaminated by the adherence of dust and so forth.

Thus, as shown in FIG. 37 and FIG. 38, an image forming apparatus of this example has a configuration provided with an imaging surface cleaning section 1510 that cleans imaging surface (here, the underside) 170a of two-dimensional sensor 170, the imaging section.

In an image forming apparatus of this example, imaging surface cleaning section 1510 has cleaning pad 1511 that is retracted from imaging surface 170a of two-dimensional sensor 170 when object imaging is performed by two-dimensional sensor 170, as shown in FIG. 38, and is advanced onto imaging surface 170a of two-dimensional sensor 170 when object imaging is not performed by two-dimensional sensor 170, as shown in FIG. 37.

Cleaning pad 1511 is supported so as to be advanced onto and retracted from imaging surface 170a of two-dimensional sensor 170 by linkage member 1512 whose operation is linked to opening and closing operations of top-surface paper ejection tray 150.

That is to say, as shown in FIG. 37, in an image forming apparatus of this example, when top-surface paper ejection tray 150 is in a closed state, cleaning pad 1511 is advanced onto imaging surface 170a of two-dimensional sensor 170 in opposition to the elastic force of tensile coil spring 1513 as a result of front edge 1512a of linkage member 1512 coming into contact with object placement surface 161 of object placement platform 160 of apparatus body 101.

Also, as shown in FIG. 38, in an image forming apparatus of this example, when top-surface paper ejection tray 150 is in an open state, cleaning pad 1511 is retracted from imaging surface 170a of two-dimensional sensor 170 pushed by the elastic force of tensile coil spring 1513 as a result of front edge 1512a of linkage member 1512 becoming separated from object placement surface 161 of object placement platform 160 of apparatus body 101.

Thus, in an image forming apparatus of this example, imaging surface 170a of two-dimensional sensor 170 is cleaned by cleaning pad 1511 through the advance and retraction of cleaning pad 1511 with respect to imaging surface 170a of two-dimensional sensor 170, linked to top-surface paper ejection tray 150 opening and closing operations.

Therefore, in an image forming apparatus of this example, imaging surface 170a of two-dimensional sensor 170 can be cleaned by cleaning pad 1511 each time top-surface paper ejection tray 150 is opened and closed for performing object imaging, enabling degradation of the quality of a captured image due to contamination of imaging surface 170a to be prevented.

Also, as cleaning of imaging surface 170a of two-dimensional sensor 170 by cleaning pad 1511 in an image forming apparatus of this example is linked to object placement platform 160 opening and closing operations, it is not necessary for an operator to clean imaging surface 170a, and operations for performing imaging are simplified.

A sponge, brush, nonwoven fabric, or the like can be used as cleaning pad 1511. Of these, fine nonwoven fabric used for cleaning eyeglasses, for example, is particularly effective for cleaning imaging surface 170a of two-dimensional sensor 170.

### Embodiment 12

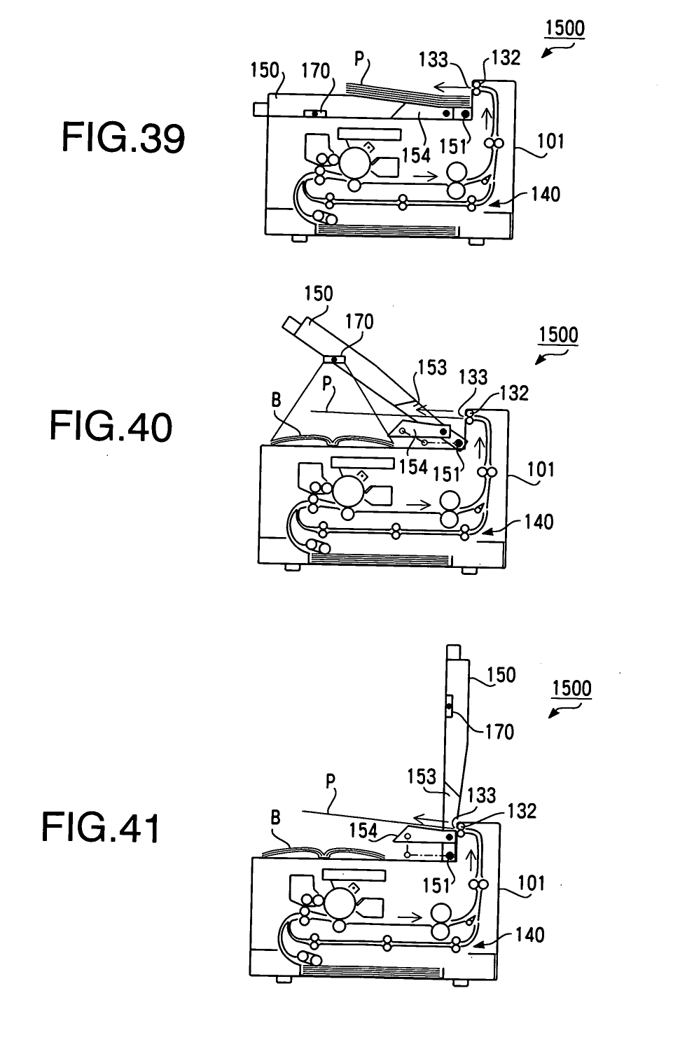

An image forming apparatus according to Embodiment 12 of the present invention will now be described with reference to FIG. 39, FIG. 40, and FIG. 41. FIG. 39 is a schematic configuration diagram showing the configuration of an image forming apparatus according to Embodiment 12 of the present invention with the top-surface paper ejection tray in a closed state, FIG. 40 is a schematic configuration diagram showing the configuration of an image forming apparatus according to Embodiment 12 of the present invention with the top-surface paper ejection tray opened to the imaging position, and FIG. 41 is a schematic configuration diagram showing the configuration of an image forming apparatus according to Embodiment 12 of the present invention with the top-surface paper ejection tray opened to the maximum extent.

In the above-described image forming apparatuses 1500, a selection is made as to whether an object image captured by means of two-dimensional sensor 170 is to be stored in memory as image data or printed onto paper (printed out).

When a captured object image is printed onto paper, trial printout may be performed to check whether the captured object image is printed with the desired layout and quality. When this trial printout is performed, it is desirable for the trial printout paper to be ejected from the apparatus in a state in which it can easily be checked by the operator.

However, with image forming apparatus 100 in which top-surface paper ejection tray 150 is opened when performing object imaging, for example, as shown in FIG. 4 and FIG. 5, paper P is ejected at the rear of top-surface paper ejection tray 150 in a blind spot for the operator, making it difficult to check trial printout paper P.

Thus, as shown in FIG. 39, FIG. 40, and FIG. 41, image forming apparatus 1500 of this example employs a configuration in which top-surface paper ejection tray 150 is provided with large aperture 153 that allows passage of paper P ejected by top-surface paper ejection rollers 132, and aperture opening/closing member 154 that performs opening and closing of aperture 153 linked to opening and closing operations of top-surface paper ejection tray 150.

Here, as shown in FIG. 39, FIG. 40 and FIG. 41, aperture opening/closing member 154 is supported in an area of open aperture 153 of top-surface paper ejection tray 150 so as to form a four-sections parallel link with spindle 151 of top-surface paper ejection tray 150.

When top-surface paper ejection tray 150 is in a closed state, aperture opening/closing member 154 is placed in a position in which it closes aperture 153 of top-surface paper ejection tray 150, as shown in FIG. 39, and when top-surface paper ejection tray 150 is opened to the imaging position, aperture opening/closing member 154 is placed in a position in which it opens aperture 153 of top-surface paper ejection tray 150, as shown in FIG. 40.

By this means, after top-surface paper ejection tray 150 has been opened to the imaging position and imaging has been performed by two-dimensional sensor 170, trial printout paper P is ejected onto the object (book B) via aperture 153 of top-surface paper ejection tray 150, as shown in FIG. 40.

Therefore, with image forming apparatus 1500 of this example, paper P used for trial printout when an object is imaged can be checked extremely easily.

Also, as shown in FIG. 41, image forming apparatus 1500 of this example is configured so that when top-surface paper ejection tray 150 is opened to an angle of opening that cuts off the ejection path of ejected paper P, aperture 153 of top-surface paper ejection tray 150 is opposite top-surface paper ejection aperture 133 provided at the top of apparatus body 101.

By this means, with image forming apparatus 1500 of this example, as shown in FIG. 41, ejected paper P is ejected onto the object (book B) via aperture 153 of top-surface paper ejection tray 150 without becoming jammed even when top-surface paper ejection tray 150 is opened to an angle of opening that cuts off the ejection path of ejected paper P.

In image forming apparatus 1500 of this example, it is desirable for ejected trial printout paper P to be ejected onto the object (book B) with its front and back sides reversed by reverse transportation unit 140.

By this means, trial printout paper P is ejected image-side upward onto the object (book B), enabling trial printout paper P to be checked easily.

### Embodiment 13

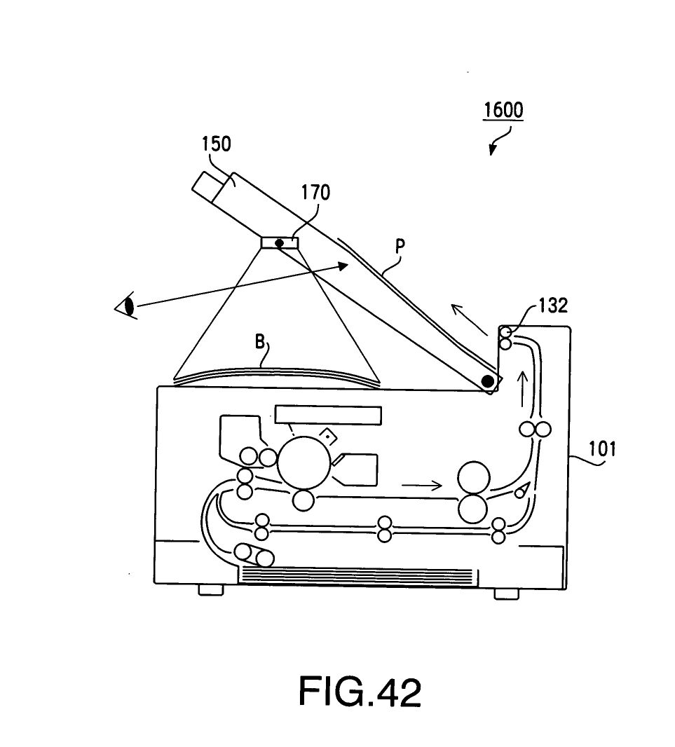

An image forming apparatus according to Embodiment 13 of the present invention will now be described with reference to FIG. 42. FIG. 42 is a schematic configuration diagram showing the configuration of an image forming apparatus according to Embodiment 13 of the present invention with the top-surface paper ejection tray opened to the imaging position.

In image forming apparatus 1500 according to Embodiment 12 shown in FIG. 39, FIG. 40, and FIG. 41, paper P is ejected onto an object (book B) via aperture 153 of top-surface paper ejection tray 150 to enable trial printout paper P output when object imaging is performed to be checked easily.

Therefore, in ejecting paper P printed during continuous imaging of book B, for example, onto top-surface paper ejection tray 150 after trial printout, a difficulty in terms of operability with this image forming apparatus 1500 is the necessity of either delaying ejection of paper P until all imaging is finished, or opening and closing top-surface paper ejection tray 150 each time imaging is performed.

Also, with this image forming apparatus 1500, the provision of aperture 153 and aperture opening/closing member 154 on top-surface paper ejection tray 150 makes the structure of top-surface paper ejection tray 150 rather complicated.

Thus, as shown in FIG. 42, image forming apparatus 1600 of this example employs a configuration in which, for at least part of top-surface paper ejection tray 150, paper P ejected by top-surface paper ejection rollers 132 can be seen from the underside of top-surface paper ejection tray 150.

Specifically, in image forming apparatus 1600 of this example, at least part of top-surface paper ejection tray 150 is transparent or in the form of a mesh.

By this means, in image forming apparatus 1600 of this example, paper P ejected onto top-surface paper ejection tray 150 can be checked extremely easily through the transparent or mesh part of top-surface paper ejection tray 150 as shown in FIG. 42.

### Embodiment 14

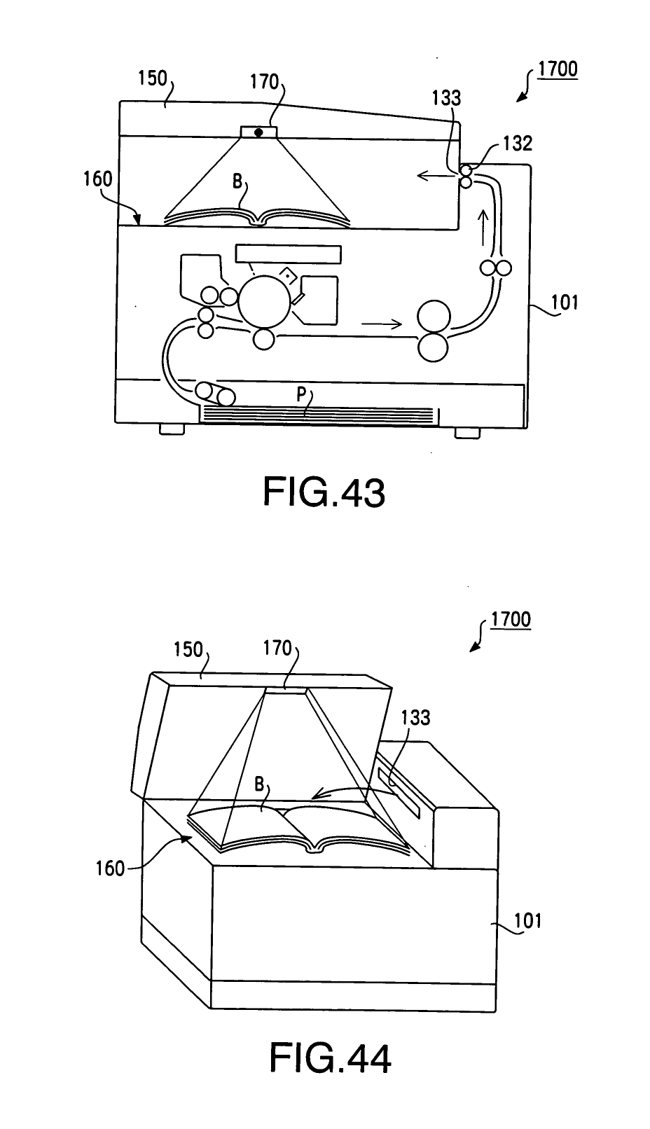

An image forming apparatus according to Embodiment 14 of the present invention will now be described with reference to FIG. 43 and FIG. 44. FIG. 43 is a schematic configuration diagram showing the configuration of an image forming apparatus according to Embodiment 14 of the present invention with the top-surface paper ejection tray opened to the imaging position, and FIG. 44 is a schematic oblique drawing showing the configuration of an image forming apparatus according to Embodiment 14 of the present invention with the top-surface paper ejection tray opened to the imaging position.

In the above-described image forming apparatuses, spindle 151 of top-surface paper ejection tray 150 is installed parallel to top-surface paper ejection rollers 132, and the top surface of top-surface paper ejection tray 150 is positioned lower than top-surface paper ejection aperture 133, enabling paper P to be ejected without becoming jammed irrespective of the angle of opening of top-surface paper ejection tray 150.

However, when top-surface paper ejection tray 150 is supported so as to open and close freely with respect to the top surface of apparatus body 101 by a spindle (not shown) parallel to the direction of ejection of paper P ejected by top-surface paper ejection rollers 132, as in image forming apparatus 1700 of this example shown in FIG. 43 and FIG. 44, depending on the angle of opening of top-surface paper ejection tray 150, ejected paper P may become jammed against opened top-surface paper ejection tray 150.

Thus, as shown in FIG. 43 and FIG. 44, image forming apparatus 1700 of this example employs a configuration in which, when an object (book B) placed on object placement platform 160 is imaged by means of two-dimensional sensor 170, top-surface paper ejection tray 150 is opened to an angle of opening at which it does not obstruct paper P ejected by top-surface paper ejection rollers 132.

By this means, jamming of ejected paper P against opened top-surface paper ejection tray 150 is eliminated in image forming apparatus 1700 of this example.

### Embodiment 15

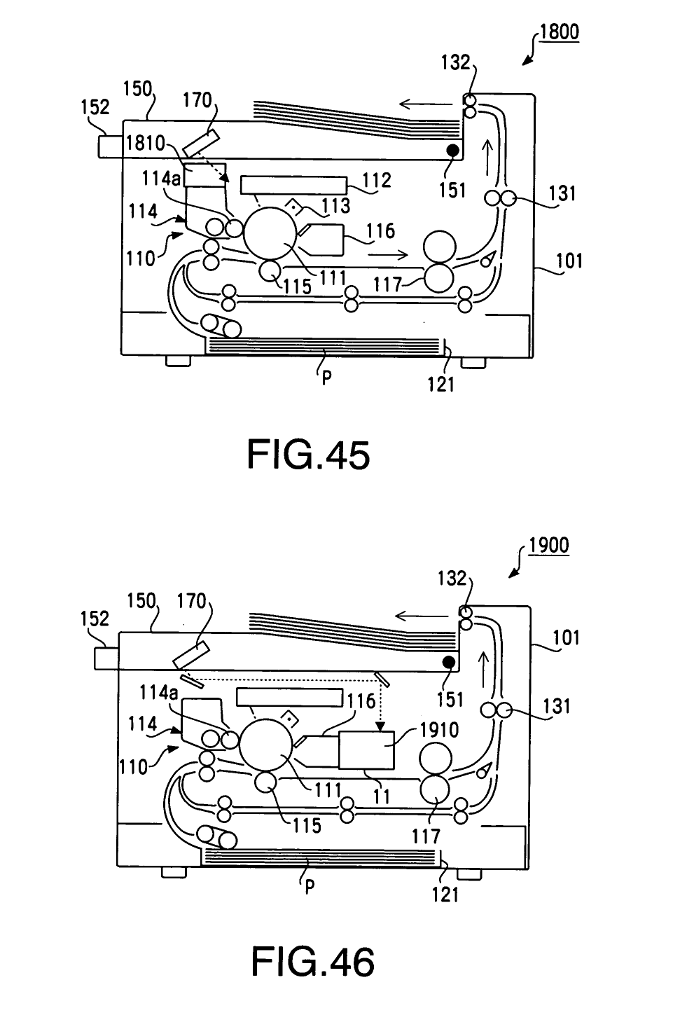

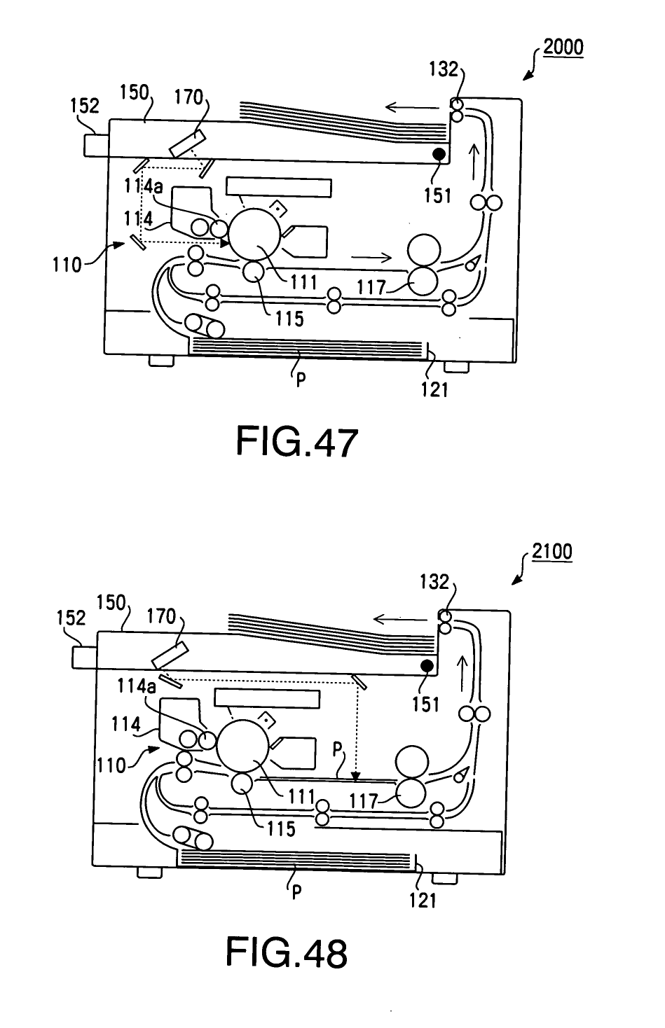

An image forming apparatus according to Embodiment 15 of the present invention will now be described with reference to FIG. 45, FIG. 46, FIG. 47, and FIG. 48. FIG. 45 is a schematic configuration diagram showing the configuration of an image forming apparatus according to Embodiment 15 of the present invention with the top-surface paper ejection tray in a closed state, FIG. 46 is a schematic configuration diagram showing another configuration of an image forming apparatus according to Embodiment 15 of the present invention with the top-surface paper ejection tray in a closed state, FIG. 47 is a schematic configuration diagram showing yet another configuration of an image forming apparatus according to Embodiment 15 of the present invention with the top-surface paper ejection tray in a closed state, and FIG. 48 is a schematic configuration diagram showing still another configuration of an image forming apparatus according to Embodiment 15 of the present invention with the top-surface paper ejection tray in a closed state.

Apart from imaging an object placed on object placement platform 160, above-described two-dimensional sensor 170 can also be made to function as an ordinary sensor.

Thus, image forming apparatus 1800 shown in FIG. 45 is configured so that, when top-surface paper ejection tray 150 is in a closed state, two-dimensional sensor 170 is made to function as a sensor of a remaining developer detection section that detects the remaining amount of developer in a developer container 1810 that holds developer for forming images by means of image forming unit 110 (here, the developer supplied to developing unit 114). It is possible, for example, to make part of developer container 1810 of an optically transparent material and install a light source that shines light on developer container 1810, then analyze the color distribution, density distribution, or the like of an image captured by two-dimensional sensor 170, and determine the remaining amount of developer based on the results of that analysis.

By this means, in image forming apparatus 1800 shown in FIG. 45, the remaining amount of developer in developer container 1810 can be detected using object imaging two-dimensional sensor 170, without newly installing a sensor of a remaining developer detection section.

Image forming apparatus 1900 shown in FIG. 46 is configured so that, when top-surface paper ejection tray 150 is in a closed state, two-dimensional sensor 170 is made to function as sensor of a waste toner full-capacity detection section that detects whether or not waste toner container 1910 that holds waste toner produced when an image is formed by image forming unit 110 is full. It is possible, for example, to make part of waste toner container 1910 of an optically transparent material and install a light source that shines light on waste toner container 1910, then analyze the color distribution, density distribution, or the like of an image captured by two-dimensional sensor 170, and determine the accumulated amount of waste developer based on the results of that analysis.

By this means, in image forming apparatus 1900 shown in FIG. 46, whether or not waste toner container 1910 is full of waste toner can be detected using object imaging two-dimensional sensor 170, without newly installing a sensor of a waste toner full-capacity detection section.

Image forming apparatus 2000 shown in FIG. 47 is configured so that, when top-surface paper ejection tray 150 is in a closed state, two-dimensional sensor 170 is made to function as a sensor of an image density detection section that detects the image density of an image formed on photosensitive drum 111 by image forming unit 110. It is possible, for example, to install a light source that shines light on photosensitive drum 111 at a level at which exposure is not performed, then analyze the color distribution, density distribution, or the like of an image captured by two-dimensional sensor 170, and determine the image density of an image formed on photosensitive drum 111 based on the results of that analysis.

By this means, in image forming apparatus 2000 shown in FIG. 47, the image density of an image formed on photosensitive drum 111 by image forming unit 110 can be detected using object imaging two-dimensional sensor 170, without newly installing a sensor of an image density detection section.

Image forming apparatus 2100 shown in FIG. 48 is configured so that, when top-surface paper ejection tray 150 is in a closed state, two-dimensional sensor 170 is made to function as a sensor of an image density detection section that detects the image density of an image formed on paper P by image forming unit 110. It is possible, for example, to install a light source that shines light on paper P to which a toner image has been transferred, then analyze the color distribution, density distribution, or the like of an image captured by two-dimensional sensor 170, and determine the image density of an image formed on paper P based on the results of that analysis.

By this means, in image forming apparatus 2100 shown in FIG. 48, the image density of an image formed on paper P by image forming unit 110 can be detected using object imaging two-dimensional sensor 170, without newly installing a sensor of an image density detection section.

In image forming apparatus 2100 shown in FIG. 48, it is also possible to detect the amount of adhering toner per unit area of an image (toner) formed on paper P by means of two-dimensional sensor 170 with top-surface paper ejection tray 150 in a closed state, and calculate the amount of toner consumed.

### Embodiment 16

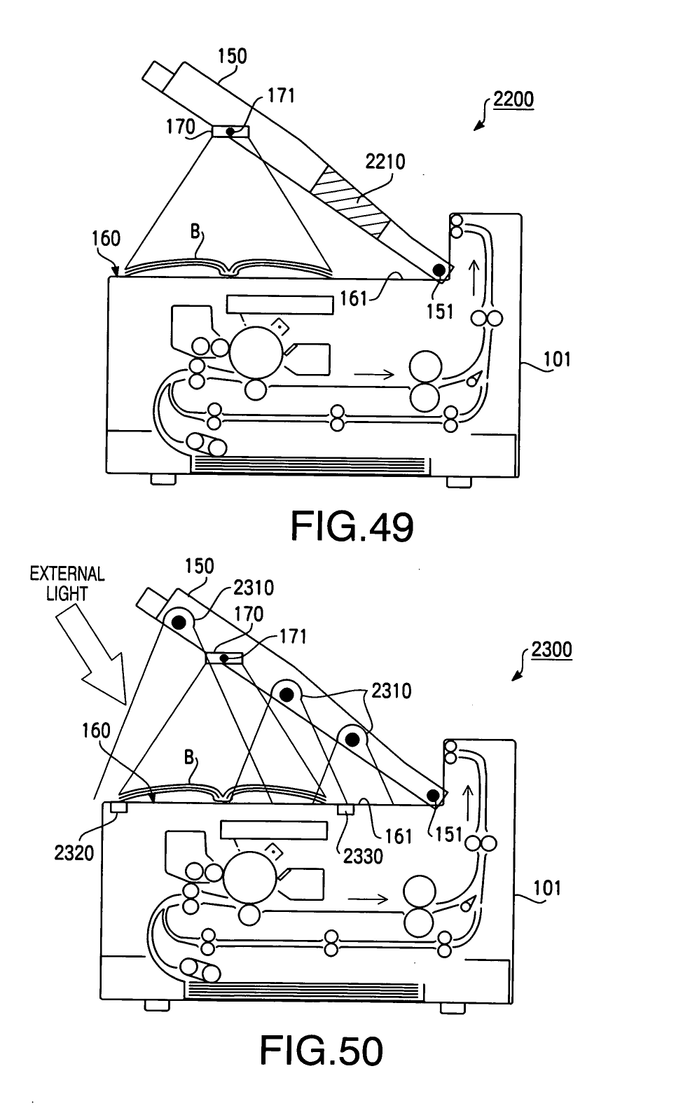

An image forming apparatus according to Embodiment 16 of the present invention will now be described with reference to FIG. 49. FIG. 49 is a schematic configuration diagram showing the configuration of an image forming apparatus according to Embodiment 16 of the present invention with the top-surface paper ejection tray in an open state.

As stated above, with an image forming apparatus configured so that object placement surface 161 of object placement platform 160 is exposed by pivoted movement of top-surface paper ejection tray 150, the brightness of object placement surface 161 on the pivoting side of top-surface paper ejection tray 150 (the area near spindle 151) tends to be lower than the brightness of object placement surface 161 on the side on which top-surface paper ejection tray 150 opens and closes.

Therefore, with an image forming apparatus configured in this way, there is a risk that, due to the decrease in brightness of object placement surface 161 on the pivoting side of top-surface paper ejection tray 150, the amount of exposure of the pivoting-side surface of an object placed on object placement surface 161 will be insufficient.

Thus, as shown in FIG. 49, an image forming apparatus 2200 of this example employs a configuration in which an optically transparent section 2210 that admits external light is provided on the pivoting side of top-surface paper ejection tray 150. Specifically, optically transparent section 2210 is configured as a transparent section, aperture, or mesh that admits light.

With image forming apparatus 2200 of this example, since external light can be admitted through optically transparent section 2210 provided on the pivoting side of top-surface paper ejection tray 150, a decrease in brightness of object placement surface 161 on the pivoting side of top-surface paper ejection tray 150 can be prevented, and insufficiency of the amount of exposure of the pivoting-side surface of an object placed on object placement surface 161 can be eliminated.

### Embodiment 17

An image forming apparatus according to Embodiment 17 of the present invention will now be described with reference to FIG. 50. FIG. 50 is a schematic configuration diagram showing the configuration of an image forming apparatus according to Embodiment 17 of the present invention with the top-surface paper ejection tray in an open state.

As explained above, with an image forming apparatus configured so that object placement surface 161 of object placement platform 160 is exposed by pivoted movement of top-surface paper ejection tray 150, it is difficult to maintain uniform brightness of object placement surface 161.

Thus, as shown in FIG. 50, an image forming apparatus 2300 of this example is equipped with a plurality of light sources 2310 running from the opening/closing side to the pivoting side of top-surface paper ejection tray 150.

Image forming apparatus 2300 of this example also includes first light quantity sensor 2320 that detects the quantity of light radiated from plurality of light sources 2310 on the opening/closing side of object placement surface 161 of object placement platform 160.

Image forming apparatus 2300 of this example further includes second light quantity sensor 2330 that detects the quantity of light radiated from plurality of light sources 2310 on the pivoting side of object placement surface 161 of object placement platform 160.

In image forming apparatus 2300 of this example, when the quantity of light detected by first light quantity sensor 2320 and the quantity of light detected by second light quantity sensor 2330 become equal through opening/closing of top-surface paper ejection tray 150, a tray stop signal that stops top-surface paper ejection tray 150 opening/closing operation is output by a tray stop signal output section (not shown).

By this means, in image forming apparatus 2300 of this example, when the quantity of light detected by first light quantity sensor 2320 and the quantity of light detected by second light quantity sensor 2330 have become equal—that is, when the brightness of object placement surface 161 has become uniform—top-surface paper ejection tray 150 opening/closing operation can be stopped by a tray stop signal output section (not shown)

A configuration may also be used in which top-surface paper ejection tray 150 is opened and closed by means of a tray opening/closing motor (not shown), and when a tray stop signal is output from the tray stop signal output section, tray opening/closing motor drive is halted by a motor control section (not shown).

By this means, top-surface paper ejection tray 150 can be automatically opened and closed by a tray opening/closing motor so that the top-surface paper ejection tray 150 opening/closing operation stops when the brightness of object placement surface 161 has become uniform.

It is also possible to provide a light adjustment section that adjusts the quantity of light of plurality of light sources 2310 individually, and for a light adjustment stop signal that stops light quantity adjustment by the light adjustment section to be output by a light adjustment stop signal output section (not shown) when the quantity of light detected by first light quantity sensor 2320 and the quantity of light detected by second light quantity sensor 2330 become equal through opening/closing of top-surface paper ejection tray 150. Specifically, for example, when the angle of opening of top-surface paper ejection tray 150 is fixed at an arbitrary angle, adjustment of the quantity of light may be stopped when the quantity of light of plurality of light sources 2310 is varied gradually and then the quantity of light detected by first light quantity sensor 2320 and the quantity of light detected by second light quantity sensor 2330 become equal.

By this means, the brightness of object placement surface 161 can be made uniform even when the angle of opening of top-surface paper ejection tray 150 is an arbitrary angle.

It is desirable for the above-described light adjustment section to have an automatic light adjustment function that automatically adjusts the quantity of light of plurality of light sources 2310 on an individual basis. By this means, light adjustment operations by the light adjustment section can be stopped automatically by means of a light adjustment control section (not shown) when a light adjustment stop signal is output by the above-described light adjustment stop signal output section.

When provision is made to stop top-surface paper ejection tray 150 at an arbitrary angle of opening, it is desirable for imaging surface 170a of two-dimensional sensor 170 to be in a position and attitude that allow imaging of an object on object placement platform 160 whatever the angle of opening at which top-surface paper ejection tray 150 stops.

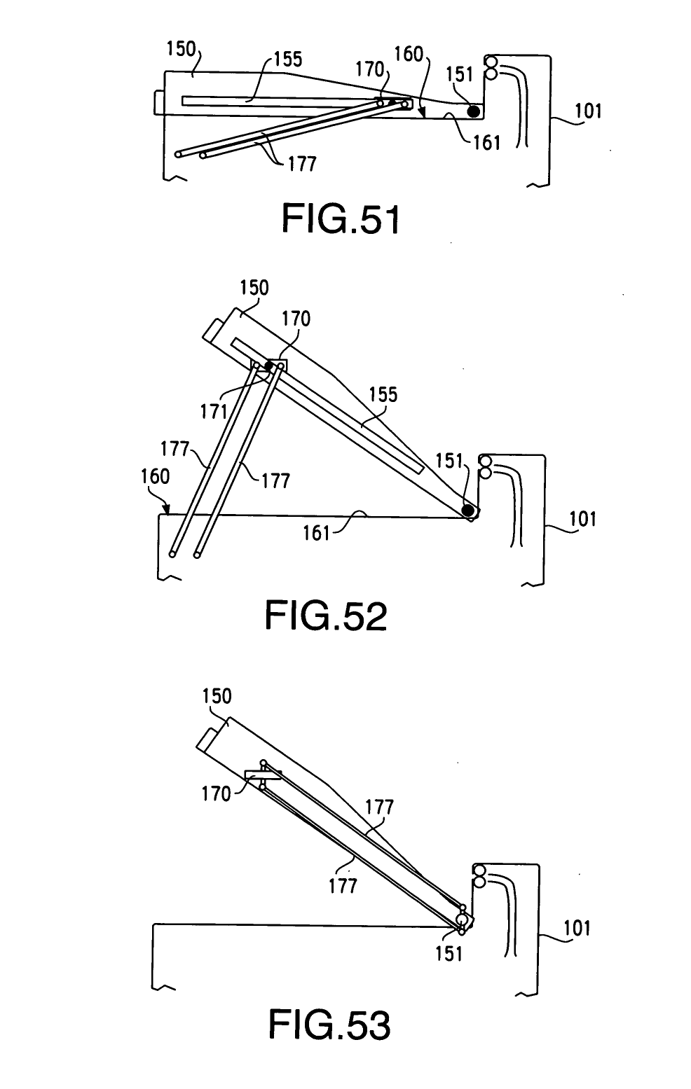

Thus, as shown in FIG. 51, FIG. 52, and FIG. 53, in the above-described image forming apparatuses, a configuration is used in which two-dimensional sensor 170 is supported by four-sections parallel link swiveling sections 177 that swivel linked to top-surface paper ejection tray 150 opening/closing operations, so that imaging surface (underside) 170a of two-dimensional sensor 170 is always parallel to object placement surface 161 of object placement platform 160.

As shown in FIG. 51 and FIG. 52, when, of four-sections parallel link swiveling sections 177, the two not supporting two-dimensional sensor 170 are positioned on apparatus body 101, fulcrum 171 of two-dimensional sensor 170 slides along slit 155 provided in top-surface paper ejection tray 150.

Also, as shown in FIG. 53, if one of the two of the four-sections parallel link swiveling sections 177 not supporting two-dimensional sensor 170 is provided on spindle 151 of top-surface paper ejection tray 150, and the other is provided on apparatus body 101, it is no longer necessary to slide two-dimensional sensor 170.

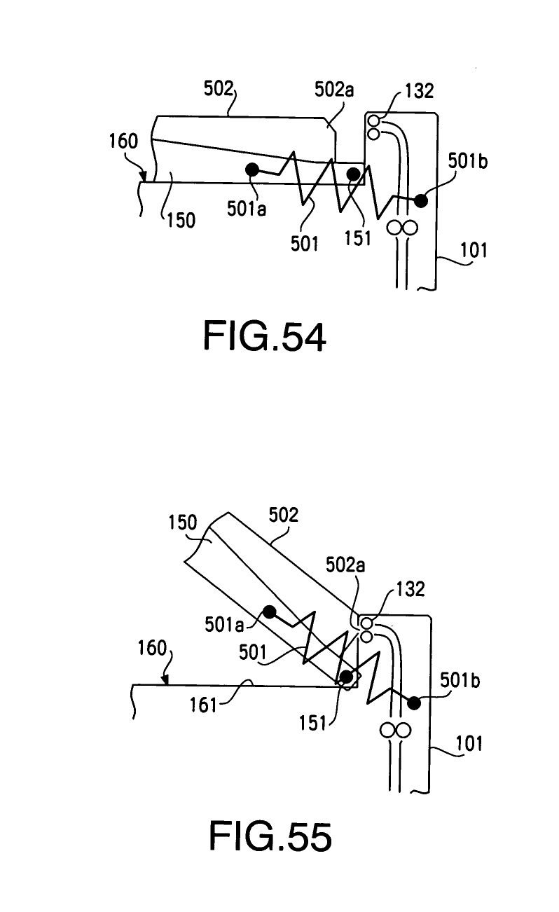

On the other hand, the tray latching section shown in FIG. 54 and FIG. 55, for example, can be used as a tray latching section that latches top-surface paper ejection tray 150 in a predetermined closed position and open position.

The tray latching section shown in FIG. 54 and FIG. 55 is provided with contractive coil spring 501, and opening/closing stopping plate 502 as an opening/closing stopping section comprising a paper guide of top-surface paper ejection tray 150.

One end 501a of coil spring 501 is attached to top-surface paper ejection tray 150, and the other end 501b is attached to apparatus body 101, so that coil spring 501 goes beyond spindle 151, which is the opening/closing fulcrum of top-surface paper ejection tray 150, during top-surface paper ejection tray 150 opening/closing operation.

When top-surface paper ejection tray 150 has been opened to an angle of opening at which an object placed on object placement platform 160 is imaged by means of two-dimensional sensor 170, chamfer 502a of opening/closing stopping plate 502 comes into contact with apparatus body 101, and stops opening/closing of top-surface paper ejection tray 150 by coil spring 501.

That is to say, with this tray latching section, when top-surface paper ejection tray 150 is in a closed state, as shown in FIG. 54, coil spring 501 is positioned lower than spindle 151 of top-surface paper ejection tray 150, and a rotational tendency in the closing direction is conveyed to top-surface paper ejection tray 150.

On the other hand, when top-surface paper ejection tray 150 is in an open state, as shown in FIG. 55, coil spring 501 is positioned higher than spindle 151 of top-surface paper ejection tray 150, and a rotational tendency in the opening direction is conveyed to top-surface paper ejection tray 150.

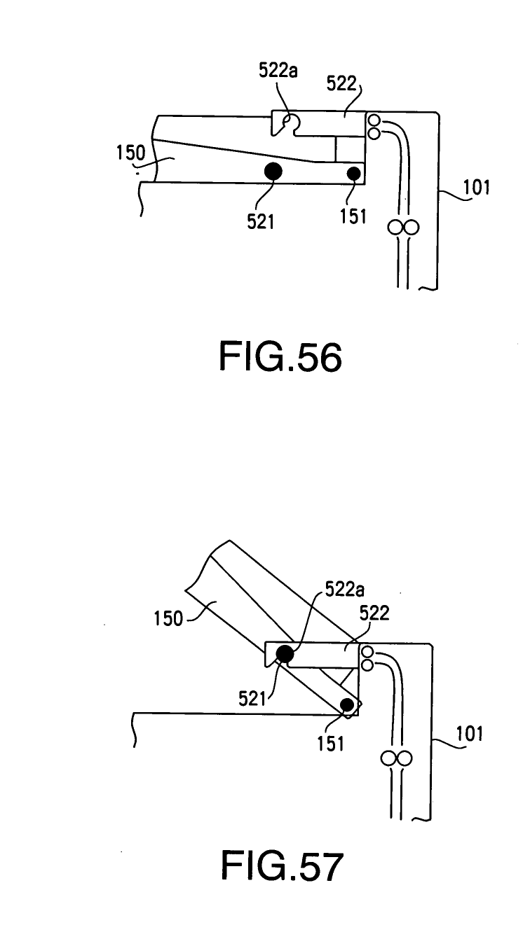

FIG. 56 and FIG. 57 are essential-part schematic configuration diagrams showing the configuration of another tray latching section. The tray latching section shown in FIG. 56 and FIG. 57 is composed of latch pin 521 implanted in top-surface paper ejection tray 150, and latch plate 522 attached to apparatus body 101.

With this tray latching section, when top-surface paper ejection tray 150 in a closed state as shown in FIG. 56 is opened to an angle of opening at which an object placed on object placement platform 160 is imaged by means of two-dimensional sensor 170, as shown in FIG. 57, latch pin 521 of top-surface paper ejection tray 150 engages with latch slot 522a in latch plate 522, and top-surface paper ejection tray 150 is latched in a predetermined open position.

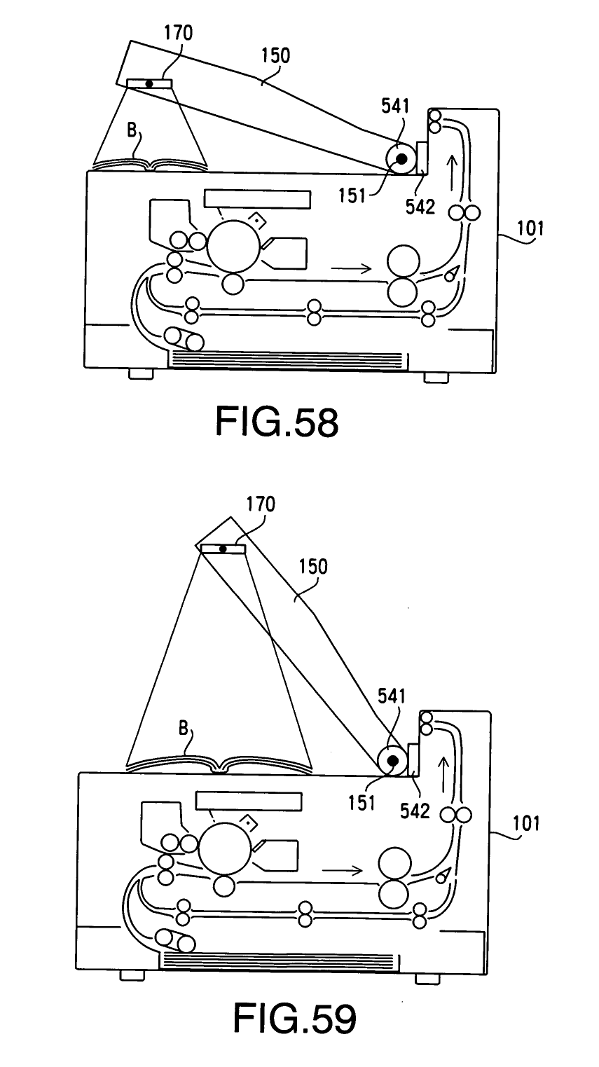

FIG. 58 and FIG. 59 are schematic configuration diagrams of an image forming apparatus that has a tray latching section that latches the top-surface paper ejection tray in a position at which the top-surface paper ejection tray is opened to an arbitrary angle of opening.

The tray latching section shown in FIG. 58 and FIG. 59 is composed of friction roller 541 integral with spindle 151 of top-surface paper ejection tray 150, and friction plate 542 attached to apparatus body 101. Friction roller 541 and friction plate 542 are formed from rubber, hard sponge, or the like.

With this tray latching section, a large frictional force between friction roller 541 and friction plate 542 enables top-surface paper ejection tray 150 to be latched in a position where it is opened to an arbitrary angle of opening, such as a state in which top-surface paper ejection tray 150 is opened to a small extent, as shown in FIG. 58, or a state in which top-surface paper ejection tray 150 is widely opened, as shown in FIG. 59.

As tray latching section shown in FIG. 58 and FIG. 59 latches top-surface paper ejection tray 150 at an arbitrary angle of opening by means of contact friction between friction roller 541 and friction plate 542, there is a possibility of decreasing latching efficacy of top-surface paper ejection tray 150 due to wear of friction roller 541 and friction plate 542 across the ages.

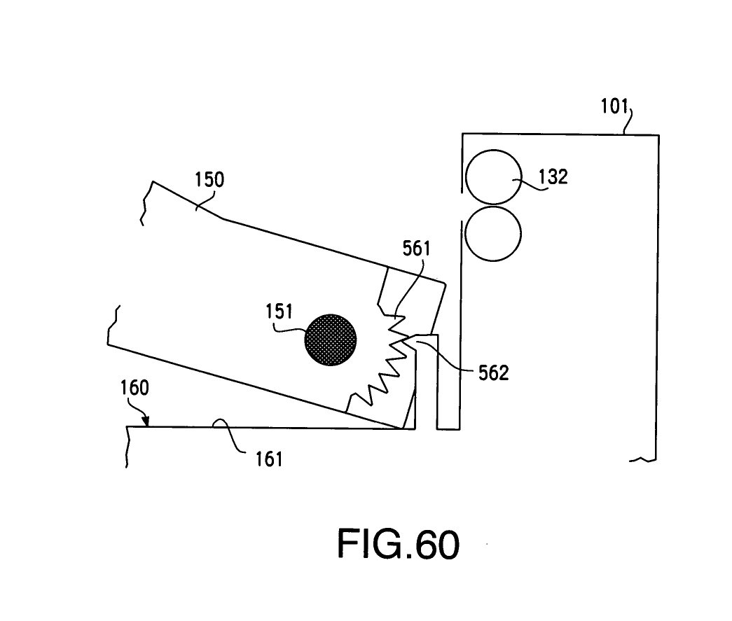

Thus, this tray latching section may be configured by forming ratchet section 561 concentric with spindle 151 of top-surface paper ejection tray 150, and having this ratchet section 56l engaged by latch pawl 562 provided on apparatus body 101, as shown in FIG. 60.

As this tray latching section latches top-surface paper ejection tray 150 through the engagement of ratchet section 561 with latch pawl 562, there is little possibility of decreasing latching efficacy of top-surface paper ejection tray 150 across the ages.

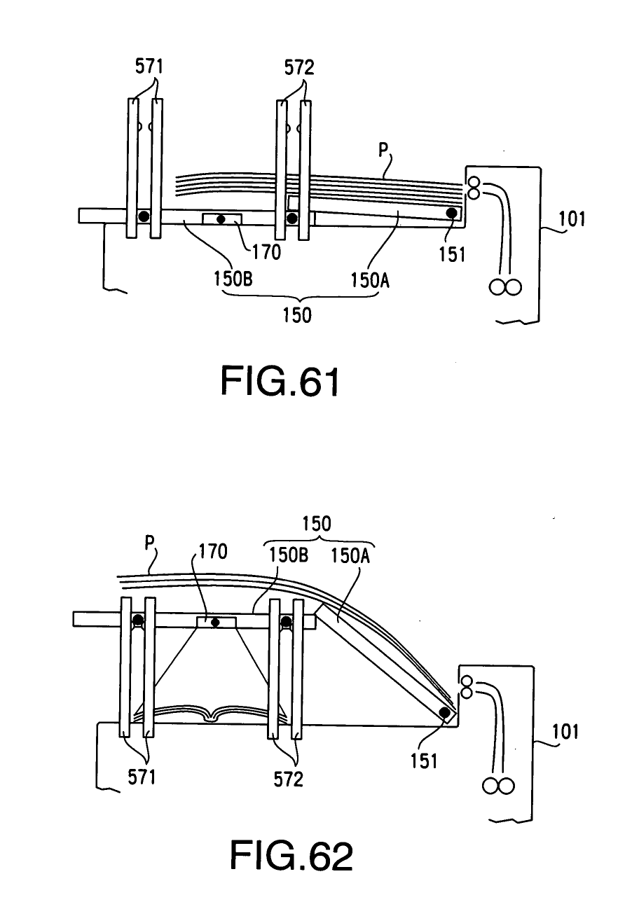

As another tray latching section that latches top-surface paper ejection tray 150 in a predetermined closed position and open position, a configuration may be employed in which, as shown in FIG. 61 and FIG. 62, top-surface paper ejection tray 150 comprises pivoting tray section 150A, supported in a freely pivoting fashion by spindle 151, upstream in the paper P ejection direction, linked to up-and-down tray section 150B, serving as a support for two-dimensional sensor 170, supported by columns 571 and 572 so as to move freely up and down, downstream in the paper P ejection direction.

In the tray latching section shown in FIG. 61 and FIG. 62, up-and-down tray section 150B serving as two-dimensional sensor 170 support moves up and down along columns 571 and 572 while remaining horizontal, enabling two-dimensional sensor 170 to be constantly maintained in an imaging attitude.

Also, with an image forming apparatus that uses this tray latching section, since up-and-down tray section 150B moves up and down while remaining horizontal, removal of paper P ejected onto top-surface paper ejection tray 150 can be performed easily.

With the above-described image forming apparatuses, since printed paper P is ejected onto top-surface paper ejection tray 150 that is opened and closed with respect to apparatus body 101, when top-surface paper ejection tray 150 on which ejected paper P is stacked as shown in FIG. 3 is opened, there is a risk of paper P falling from top-surface paper ejection tray 150.

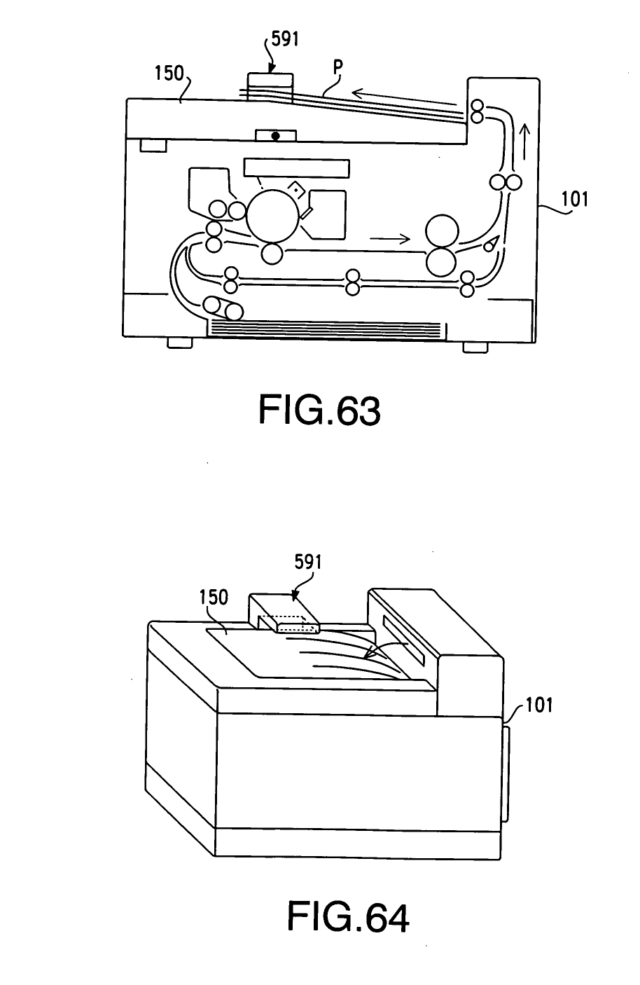

Thus, the image forming apparatus shown in FIG. 63 and FIG. 64 employs a configuration in which paper fall prevention member 591 that prevents paper ejected onto top-surface paper ejection tray 150 from falling is provided on the opening side of top-surface paper ejection tray 150.

With this image forming apparatus shown in FIG. 63 and FIG. 64, even if top-surface paper ejection tray 150 is opened with ejected paper P stacked upon it, paper P ejected onto top-surface paper ejection tray 150 can be prevented from falling by means of paper fall prevention member 591.

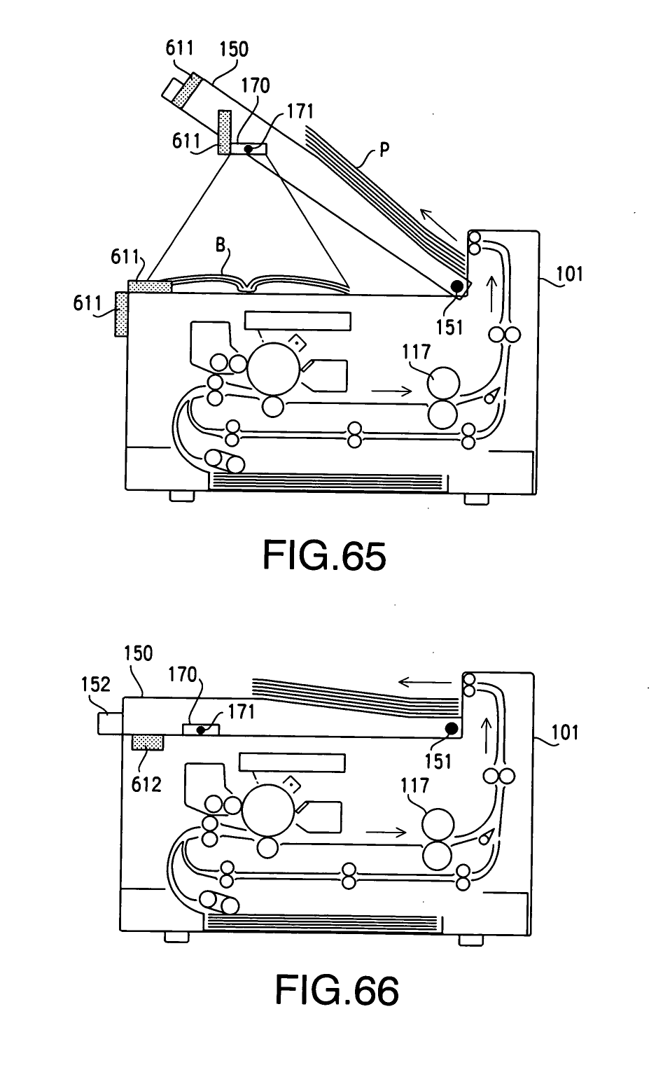

In the above-described image forming apparatuses, it is desirable for the captured image of an object to be displayed on monitors 611 when object imaging is performed by two-dimensional sensor 170, as shown in FIG. 65, for example. Displaying the captured image of an object on monitors 611 in this way enables object imaging by means of two-dimensional sensor 170 to be performed without mistakes.

FIG. 65 shows four monitors 611, but it is sufficient for at least one monitor 611 to be provided.

In the above-described image forming apparatuses, it is also possible to provide open/closed detection section 612 that detects the open/closed state of top-surface paper ejection tray 150, as shown in FIG. 66, for example, and to operate in a power saving mode that cuts the power consumption of the heat source (heater, IH coil, or the like) of fixing unit 117 when the open/closed detection section detects that top-surface paper ejection tray 150 is in a closed state, and cancel the power saving mode when the open/closed detection section detects that top-surface paper ejection tray 150 is in an open state.

With this image forming apparatus shown in FIG. 66, the heat source of fixing unit 117 can be turned on and off by opening and closing top-surface paper ejection tray 150, enabling fast startup of fixing unit 117 when performing image printing.

When an object image captured by two-dimensional sensor 170 is stored in memory without being printed—that is, when image printing is not performed—it is desirable for the power saving mode not to be canceled even if the open/closed detection section detects that top-surface paper ejection tray 150 is in an open state.

An image forming apparatus according to the present invention ejects paper onto the top surface of the body of the apparatus, and uses the top-surface paper ejection tray as a support for the imaging section, enabling an image forming apparatus with three-dimensional object imaging capability to be made compact, and its footprint also to be made smaller, and is therefore useful as an image forming apparatus such as a monochrome or color copier, printer, or facsimile that employs an image forming method such as electrophotography, electrostatic recording, ionography, or magnetic recording, and more particularly as an image forming apparatus capable of imaging a three-dimensional object.

The present invention is not limited to the above-described embodiments, and various variations and modifications may be possible without departing from the scope of the present invention.

This application is based on Japanese Patent Application No. 2005-142725 filed on May 16, 2005, the entire content of which is expressly incorporated by reference herein.

What is claimed is:

1. An image forming apparatus comprising:
an image forming section that forms an image;
a top-surface paper ejection section that ejects paper on which the image has been formed by said image forming section onto a top surface of an apparatus body of the image forming apparatus;
a top-surface paper ejection tray that can be opened and closed with respect to said apparatus body and receives the paper ejected by said top-surface paper ejection section;
an object placement platform, of which an object placement surface on which an object is placed is exposed by opening said top-surface paper ejection tray; and
an imaging section that images an object placed on said object placement platform, with said top-surface paper ejection tray in an open state with respect to said apparatus body as a support.

2. The image forming apparatus according to claim 1, wherein said image forming section is provided on an underside of said top-surface paper ejection tray, and is positioned so as to be shielded from outside by said top-surface paper ejection tray and said object placement platform when said top-surface paper ejection tray is in a closed state with respect to said apparatus body.

3. The image forming apparatus according to claim 1, wherein:
said top-surface paper ejection tray is pivotably supported with respect to said apparatus body by a spindle; and
said imaging section is positioned inward from an opposite-side edge from a spindle side of said underside of said top-surface paper ejection tray.

4. The image forming apparatus according to claim 3, wherein:
when:
an effective tray length from said imaging section to said spindle on said top-surface paper ejection tray is designated L;
an imaging range width of a possible imaging area of said imaging section on said object placement surface is designated La;
a non-imaging area width from said spindle to said possible imaging area on said object placement surface is designated Lb; and
an angle of opening of said top-surface paper ejection tray with respect to said apparatus body when imaging is performed by said imaging section is designated θ,
said angle of opening θ, said tray length L, said imaging range width La, and said non-imaging area width Lb are set to values that satisfy the relationships θ≦50 degrees and cos θ=((La/2)+Lb)/L.

5. The image forming apparatus according to claim 3, wherein:
when:
an effective tray length from said spindle to said imaging section on said top-surface paper ejection tray is designated L; and
a maximum tray length from said spindle to said opposite-side edge on said top-surface paper ejection tray is designated Lmax,
said effective tray length L is set so that L≦0.9×Lmax.

6. The image forming apparatus according to claim 3, wherein:
when:
an effective tray length from said spindle to said imaging section on said top-surface paper ejection tray is designated L; and
a maximum tray length from said spindle to said opposite-side edge on said top-surface paper ejection tray is designated Lmax,
said effective tray length L is set so that 0.7×Lmax≦L≦0.9×Lmax.

7. The image forming apparatus according to claim 1, wherein, when imaging of said object placed on said object placement surface of said object placement platform is performed, said imaging section is positioned on a vertical line crossing a center position of a possible imaging area of said imaging section on said object placement surface, irrespective of a size of said object.

8. The image forming apparatus according to claim 1, wherein:
said object placement platform has an object placement reference position mark that indicates a reference position when said object is placed on said object placement surface; and
said object placement reference position mark is set with an imaging position of said imaging section when imaging said object as a reference.

9. The image forming apparatus according to claim 8, wherein said object placement reference position mark is set so that a center of said object placement reference position mark is positioned on a vertical line crossing a center position of said imaging section in said imaging position.

10. The image forming apparatus according to claim 1, wherein at least an operating section operated by an operator when imaging is performed by said imaging section is provided in an area covered by said top-surface paper ejection tray in a closed state.

11. The image forming apparatus according to claim 1, further comprising screening members that screen gaps between both sides of said object placement platform and said top-surface paper ejection tray when said top-surface paper ejection tray is in an open state.

12. The image forming apparatus according to claim 1, wherein said imaging section is provided on said top-surface paper ejection tray through a shock-absorbing member that absorbs vibration.

13. The image forming apparatus according to claim 1, wherein said top-surface paper ejection tray is provided on said object placement platform.

14. The image forming apparatus according to claim 13, wherein said object placement platform and said apparatus body are separated from each other and a vibration-isolating member is placed between said object placement platform and said apparatus body.

15. The image forming apparatus according to claim 1, further comprising:
a light source provided on an opening/closing side of said top-surface paper ejection tray for illuminating said object; and
a reflector that is provided on an inner surface of a pivoting side of said top-surface paper ejection tray and reflects light emitted from said light source.

16. The image forming apparatus according to claim 15, further comprising a light source supporting section that movably supports said light source with respect to said top-surface paper ejection tray.

17. The image forming apparatus according to claim 1, further comprising a tray latching section that latches said top-surface paper ejection tray at a plurality of angles of opening, including at least a first angle of opening at which an object placed on said object placement platform is imaged by said imaging section, and a second angle of opening that is greater than said first angle of opening.

18. The image forming apparatus according to claim 1, further comprising a tray latching section that latches said top-surface paper ejection tray at a first angle of opening at which an object placed on said object placement platform is imaged by said imaging section, wherein said imaging section is fixed to said top-surface paper ejection tray so that, when said top-surface paper ejection tray is opened to said first angle of opening, said imaging section is placed in an attitude for imaging an object placed on said object placement platform.

19. The image forming apparatus according to claim 1, wherein said imaging section is rotatably supported with respect to said top-surface paper ejection tray.

20. The image forming apparatus according to claim 1, wherein said imaging section is supported movably along a straight line with respect to said top-surface paper ejection tray.

21. The image forming apparatus according to claim 1, wherein said imaging section is provided on an XY table that is movable in two-dimensional directions.

22. The image forming apparatus according to claim 18, further comprising a document feeding section that separates and feeds a plurality of sheet documents stacked in a document feed tray, one sheet at a time, toward a document information reading section that reads document information of said sheet documents, and ejects said sheet documents into a document ejection tray,
wherein a document reading optical system is provided that reads document information of said sheet documents fed to said document information reading section by said imaging section when said top-surface paper ejection tray is in a closed state.

23. The image forming apparatus according to claim 19, further comprising a document feeding section that separates and feeds a plurality of sheet documents stacked in a document feed tray, one sheet at a time, toward a document information reading section that reads document information of said sheet documents, and ejects said sheet documents into a document ejection tray,
wherein a rotating and latching section is provided whereby, with said top-surface paper ejection tray in a closed state, said imaging section is rotated to and latched in an attitude opposite said document information reading section.

24. The image forming apparatus according to claim 20, further comprising a document feeding section that separates and feeds a plurality of sheet documents stacked in a document feed tray, one sheet at a time, toward a document information reading section that reads document information of said sheet documents, and ejects said sheet documents into a document ejection tray,
wherein a moving and latching section is provided whereby, with said top-surface paper ejection tray in a closed state, said imaging section is rotated to an attitude opposite said document information reading section, and moved to and latched in a reading position close to said document information reading section.

25. The image forming apparatus according to claim 1, further comprising an imaging surface cleaning section that cleans an imaging surface of said imaging section.

26. The image forming apparatus according to claim 25, wherein said imaging surface cleaning section has a cleaning pad that is retracted from said imaging surface when object imaging is performed by said imaging section, and is advanced onto said imaging surface when object imaging is not performed by said imaging section.

27. The image forming apparatus according to claim 26, wherein said cleaning pad is advanced onto and retracted from said imaging surface by a linkage member that operates in conjunction with opening and closing operations of said top-surface paper ejection tray.

28. The image forming apparatus according to claim 1, wherein said top-surface paper ejection tray has:
an aperture that is large enough to allow passage of paper ejected by said top-surface paper ejection section; and
an aperture opening/closing member that performs opening and closing of said aperture in conjunction with opening and closing operations of said top-surface paper ejection tray.

29. The image forming apparatus according to claim 28, wherein, when said top-surface paper ejection tray is opened to an angle of opening that cuts off a paper ejection path of paper ejected by said top-surface paper ejection section, said aperture is opposite said paper ejection path.

30. The image forming apparatus according to claim 1, wherein at least part of said top-surface paper ejection tray is configured so that the paper ejected by said top-surface paper ejection section can be seen at least from an underside of said top-surface paper ejection tray.

31. The image forming apparatus according to claim 1, wherein said top-surface paper ejection tray is supported so as to open and close freely with respect to a top surface of said apparatus body by a spindle parallel to a direction of ejection of the paper ejected by said top-surface paper ejection section, and is opened to an angle of opening that does not obstruct the paper ejected by said top-surface paper ejection section when imaging of an object placed on said object placement platform is performed by said imaging section.

32. The image forming apparatus according to claim 1, further comprising:
a developer container that holds developer for forming images by means of said image forming section; and
a remaining developer detection section that detects a remaining amount of developer in said developer container,
wherein, when said top-surface paper ejection tray is in a closed state, said imaging section is made to function as a sensor of said remaining developer detection section.

33. The image forming apparatus according to claim 1, further comprising:
a waste toner container that holds waste toner produced when an image is formed by said image forming section; and
a waste toner full-capacity detection section that detects whether or said waste toner container is full of waste toner,
wherein, when said top-surface paper ejection tray is in a closed state, said imaging section is made to function as a sensor of said waste toner full-capacity detection section.

34. The image forming apparatus according to claim 1, further comprising an image density detection section that detects image density of an image formed by said image forming section,
wherein, when said top-surface paper ejection tray is in a closed state, said imaging section is made to function as a sensor of said image density detection section.

35. The image forming apparatus according to claim 1, wherein an optically transparent section that admits external light is provided on a pivoting side of said top-surface paper ejection tray.

36. The image forming apparatus according to claim 1, further comprising:
a plurality of light sources running from an opening/closing side to a pivoting side of said top-surface paper ejection tray;
a first light quantity sensor that detects a quantity of light radiated from said plurality of light sources on said opening/closing side of said object placement surface of said object placement platform;
a second light quantity sensor that detects a quantity of light radiated from said plurality of light sources on said pivoting side of said object placement surface of said object placement platform; and
a tray stop signal output section that outputs a tray stop signal that stops an opening/closing operation of said top-surface paper ejection tray when a quantity of light detected by said first light quantity sensor and a quantity of light detected by said second light quantity sensor become equal through opening/closing of said top-surface paper ejection tray.

37. The image forming apparatus according to claim 36, further comprising:
a tray opening/closing motor that opens and closes said top-surface paper ejection tray; and
a motor control section that halts driving of said tray opening/closing motor when said tray stop signal is output from said tray stop signal output section.

38. The image forming apparatus according to claim 1, further comprising:
a plurality of light sources provided from an opening/closing side to a pivoting side of said top-surface paper ejection tray;
a first light quantity sensor that detects a quantity of light radiated from said plurality of light sources on said opening/closing side of said object placement surface of said object placement platform;
a second light quantity sensor that detects a quantity of light radiated from said plurality of light sources on said pivoting side of said object placement surface of said object placement platform;
a light adjustment section that adjusts a quantity of light of said plurality of light sources on an individual basis; and
a light adjustment stop signal output section that outputs a light adjustment stop signal that stops light quantity adjustment by said light adjustment section when a quantity of light detected by said first light quantity sensor and a quantity of light detected by said second light quantity sensor become equal through opening/closing of said top-surface paper ejection tray.

39. The image forming apparatus according to claim 38, wherein:
said light adjustment section has an automatic light adjustment function that automatically adjusts a quantity of light of said plurality of light sources on an individual basis; and
a light adjustment control section is further provided that stops light adjustment operations by said light adjustment section when said light adjustment stop signal is output from said light adjustment stop signal output section.

40. The image forming apparatus according to claim 1, wherein said imaging section is supported by a swiveling sections of four-sections parallel link swiveling sections that swivel in conjunction with opening/closing operations of said top-surface paper ejection tray, so that an imaging surface of said imaging section is parallel to said object placement surface of said object placement platform.

41. The image forming apparatus according to claim 1, further comprising:
a contractive coil spring that is connected between said top-surface paper ejection tray and said apparatus body, and goes beyond an opening/closing fulcrum of said top-surface paper ejection tray during an opening/closing operation of said top-surface paper ejection tray; and
an opening/closing stopping section that stops opening/closing of said top-surface paper ejection tray by said coil spring at an angle of opening at which an object placed on said object placement platform is imaged by said imaging section.

42. The image forming apparatus according to claim 1, further comprising a tray latching section that latches said top-surface paper ejection tray at an angle of opening at which an object placed on said object placement platform is imaged by said imaging section.

43. The image forming apparatus according to claim 1, further comprising a tray latching section that latches said top-surface paper ejection tray in a position at which said top-surface paper ejection tray is opened to an arbitrary angle of opening.

44. The image forming apparatus according to claim 1, wherein said top-surface paper ejection tray has a configuration in which a pivoting tray section pivotably supported upstream in an ejection direction of said paper, and an up-and-down tray section serving as a support for said imaging section, supported movably up and down, downstream in an ejection direction of said paper, are linked.

45. The image forming apparatus according to claim 1, wherein said top-surface paper ejection tray has a paper fall prevention member that prevents paper ejected onto said top-surface paper ejection tray from falling.

46. The image forming apparatus according to claim 1, wherein said imaging section has a monitor that displays a captured image of an object.

47. The image forming apparatus according to claim 1, further comprising an open/closed detection section that detects an open/closed state of said top-surface paper ejection tray, wherein:
when said open/closed detection section detects that said top-surface paper ejection tray is in a closed state, operation is performed in a power saving mode that cuts power consumption of a heat source that heat-fixes an image formed on said paper by said image forming section; and
when said open/closed detection section detects that said top-surface paper ejection tray is in an open state, said power saving mode is canceled.
